(19) United States
(12) Patent Application Publication
(10) Pub. No.: US 2026/0059509 A1
(43) Pub. Date: Feb. 26, 2026

(54) PER-TRP FREQUENCY DOMAIN BASIS INDEX REMAPPING AND NON-ZERO COEFFICIENT PERMUTATION

(71) Applicant: QUALCOMM Incorporated, San Diego, CA (US)

(72) Inventors: Jing DAI, Beijing (CN); Chao WEI, Beijing (CN); Min HUANG, Beijing (CN)

(21) Appl. No.: 19/104,153

(22) PCT Filed: Nov. 2, 2022
(86) PCT No.: PCT/CN2022/129154

§ 371 Date: Feb. 14, 2025

(51) Int. Cl. H04W 72/0453; H04L 5/00

(52) U.S. Cl. CPC H04W 72/0453; H04L 5/0048

(57) ABSTRACT

A method for wireless communication at a user equipment (UE) is provided. In the method, the UE rearranges a sequence of frequency domain (FD) bases for each transmission reception point (TRP) of a plurality of TRPs based on a relative FD basis index offset of a plurality of relative FD basis index offsets and a sequence of non-zero coefficients (NZCs). Each NZC in the sequence of NZCs represents a priority of a corresponding FD basis of the sequence of FD bases. The UE further permutes the rearranged sequence of FD bases for each TRP of the plurality of TRPs based on the sequence of NZCs and a corresponding relative FD basis index offset to obtain a set of permuted FD bases, and transmits the plurality of relative FD basis index offsets for each layer of one or more layers and the set of permuted FD bases to a network entity.

### TECHNICAL FIELD

The present disclosure relates generally to communication systems, and more particularly, to per transmit receive point (TRP) frequency domain (FD) basis index remapping and non-zero coefficients (NZC) permutation for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type c communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In one aspect of the disclosure, a method, a computer-readable medium, and an apparatus are provided for wireless communication at a user equipment (UE). The apparatus may include memory; and at least one processor coupled to the memory and configured to rearrange, for each TRP of a plurality of TRPs, a sequence of FD bases based on a relative FD basis index offset of a plurality of relative FD basis index offsets and a sequence of NZCs, where each NZC in the sequence of NZCs represents a priority of a corresponding FD basis of the sequence of FD bases; permute, for each TRP of the plurality of TRPs, the rearranged sequence of FD bases based on the sequence of NZCs and a corresponding relative FD basis index offset to obtain a set of permuted FD bases; and transmit, to a network entity, the plurality of relative FD basis index offsets for each layer of one or more layers and the set of permuted FD bases.

In one aspect of the disclosure, a method, a computer-readable medium, and an apparatus are provided for wireless communication at a network entity. The apparatus may include memory; and at least one processor coupled to the memory and configured to receive, from a UE, a plurality of relative FD basis index offsets for each layer of one or more layers, where the plurality of FD basis index offsets is associated with a set of permuted FD bases; rearrange, for each TRP of a plurality of TRPs, a sequence of FD bases based on a corresponding relative FD basis index offset of the plurality of relative FD basis index offsets and a sequence of NZCs, where each NZC in the sequence of NZCs represents a priority of a corresponding FD basis of the sequence of FD bases; and permute, for each TRP of the plurality of TRPs, the rearranged sequence of FD bases based on the sequence of NZCs and a corresponding relative FD basis index offset to obtain the set of permuted FD bases.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4A is a diagram illustrating non-coherent joint transmission (NCJT) with separately pre-coded data on different TRPs.

FIG. 4B is a diagram illustrating coherent joint transmission (CJT) with jointly pre-coded data on different TRPs.

FIG. 5 is a diagram illustrating a pre-coder for one layer.

FIG. 6A is a diagram illustrating the channel state information (CSI) packing for single CSI report.

FIG. 6B is a diagram illustrating the CSI omission order for multiple CSI reports.

FIG. 7 is a diagram illustrating the FD basis index remapping in accordance with various aspects of the present disclosure.

FIGS. 8A and 8B are diagrams illustrating the FD permutation and layer interleaving for coefficient ordering.

FIGS. 9A and 9B are diagrams illustrating the FD permutation and layer interleaving for coefficient ordering.

FIG. 10 shows diagrams illustrating the FD basis index remapping for multiple TRPs in accordance with various aspects of the present disclosure.

FIG. 11 shows diagrams illustrating the NZC ordering across multiple TRPs in accordance with various aspects of the present disclosure.

FIG. 12 is a call flow diagram illustrating a method of wireless communication in accordance with various aspects of the present disclosure.

FIG. 13 is the first flowchart illustrating methods of wireless communication at a UE in accordance with various aspects of the present disclosure.

FIG. 14 is the second flowchart illustrating methods of wireless communication at a UE in accordance with various aspects of the present disclosure.

FIG. 15 is the first flowchart illustrating methods of wireless communication at a network entity in accordance with various aspects of the present disclosure.

FIG. 16 is the second flowchart illustrating methods of wireless communication at a network entity in accordance with various aspects of the present disclosure.

FIG. 17 is a diagram illustrating an example of a hardware implementation for an example apparatus and/or network entity.

FIG. 18 is a diagram illustrating an example of a hardware implementation for an example network entity.

### DETAILED DESCRIPTION

In wireless communication with multiple TRPs, a signal may be transmitted with the FD bases for different TRPs selected independently or commonly. Aspects presented herein include methods and apparatus that enable the FD basis index mapping and FD permutation for NZCs ordering across multiple TRPs to improve the efficiency of wireless communication. As presented herein, in one aspect, a UE may rearrange, for each TRP of a plurality of TRPs, a sequence of FD bases based on a relative FD basis index offset of a plurality of relative FD basis index offsets and a sequence of NZCs. Each NZC in the sequence of NZCs may represent a priority of a corresponding FD basis of the sequence of FD bases. The UE may further permute, for each TRP of the plurality of TRPs, the rearranged sequence of FD bases based on the sequence of NZCs and a corresponding relative FD basis index offset to obtain a set of permuted FD bases; and transmit, to a network entity, the plurality of relative FD basis index offsets for each layer of one or more layers and the set of permuted FD bases.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

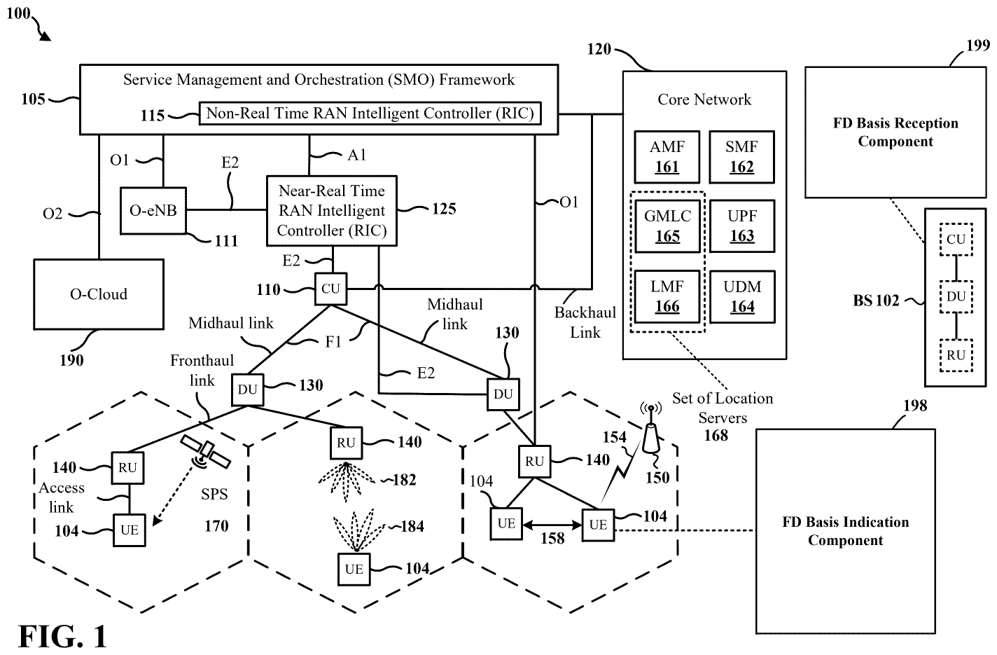

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an FD basis indication component 198. The FD basis indication component 198 may be configured to rearrange, for each TRP of a plurality of TRPs, a sequence of FD bases based on a relative FD basis index offset of a plurality of relative FD basis index offsets and a sequence of NZCs, where each NZC in the sequence of NZCs represents a priority of a corresponding FD basis of the sequence of FD bases; permute, for each TRP of the plurality of TRPs, the rearranged sequence of FD bases based on the sequence of NZCs and a corresponding relative FD basis index offset to obtain a set of permuted FD bases; and transmit, to a network entity, the plurality of relative FD basis index offsets for each layer of one or more layers and the set of permuted FD bases. In certain aspects, the base station 102 may include an FD basis reception component 199. The FD basis reception component 199 may be configured to receive, from a UE, a plurality of relative FD basis index offsets for each layer of one or more layers, where the plurality of FD basis index offsets is associated with a set of permuted FD bases; rearrange, for each TRP of a plurality of TRPs, a sequence of FD bases based on a corresponding relative FD basis index offset of the plurality of relative FD basis index offsets and a sequence of NZCs, where each NZC in the sequence of NZCs represents a priority of a corresponding FD basis of the sequence of FD bases; and permute, for each TRP of the plurality of TRPs, the rearranged sequence of FD bases based on the sequence of NZCs and a corresponding relative FD basis index offset to obtain the set of permuted FD bases. Although the following description may be focused on 5G NR, the concepts described herein may be applicable to other similar areas, such as LTE, LTE-A, CDMA, GSM, and other wireless technologies.

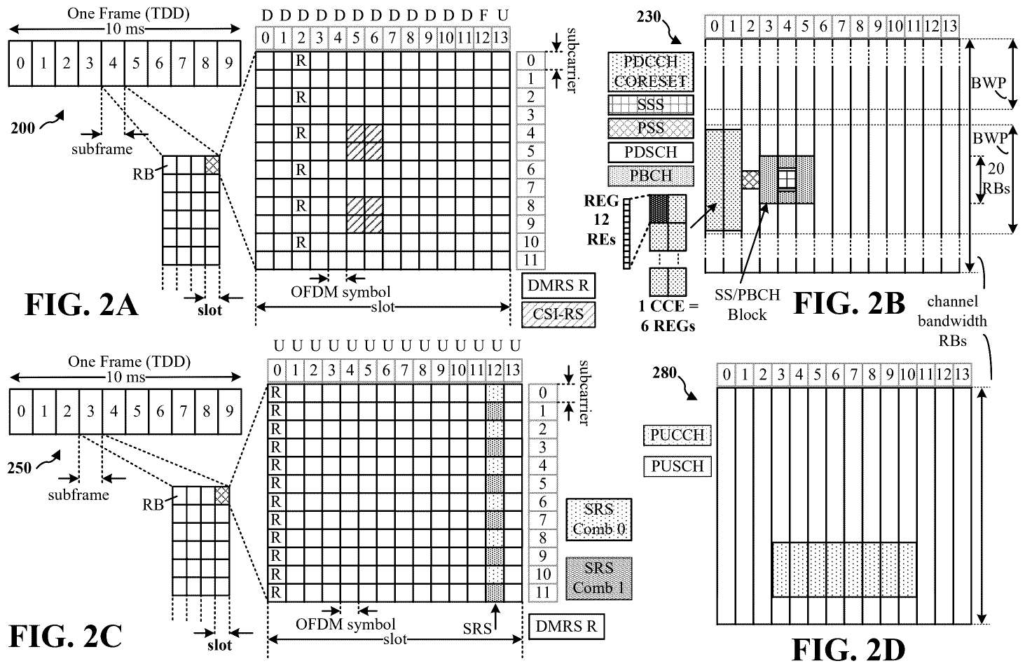

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

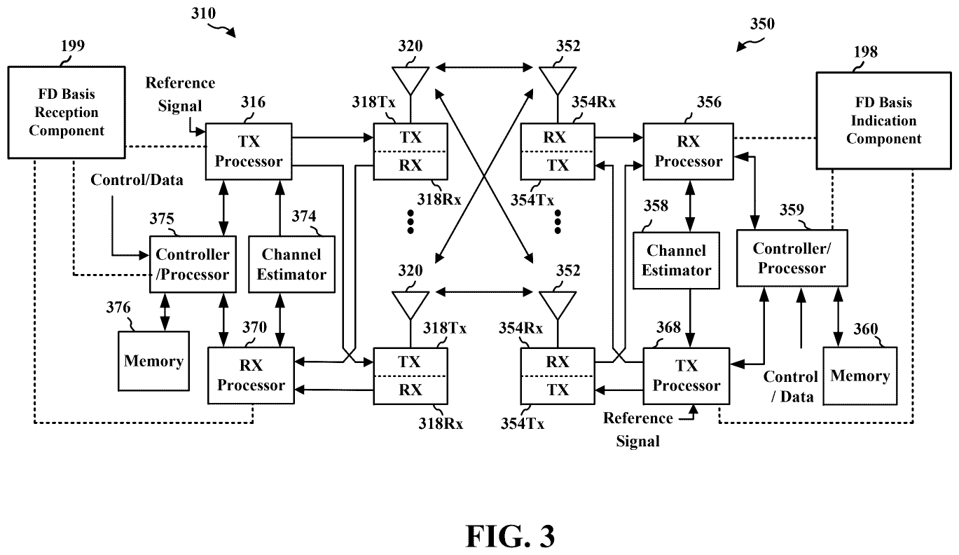

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the FD basis indication component 198 of FIG. 1.

At least one of the TX processor 316, the RX processor 370, and the controller/processor 375 may be configured to perform aspects in connection with the FD basis reception component 199 of FIG. 1.

Wireless communication with multiple TRPs may transmit a signal through NCJT. In NCJT, data may be pre-coded separately on different TRPs. In one example, the precoding of the data may be described as:

$$[ \begin{matrix}{V}_{A} & 0 \\ 0 & {V}_{B}\end{matrix} ] [ \begin{matrix}{X}_{A} \\ {X}_{B}\end{matrix} ] = [ \begin{matrix}{V}_{A} {X}_{A} \\ {V}_{B} {X}_{B}\end{matrix} ] \qquad ( 1 )$$

where the subscripts A and B represent different TRPs, the pre-coders (V_{A}, V_{B}) may each have a size of

$$( {N}_{t}^{TRP} \times {RI}^{TRP} ) , 1$$

where

$${N}_{t}^{TRP}$$

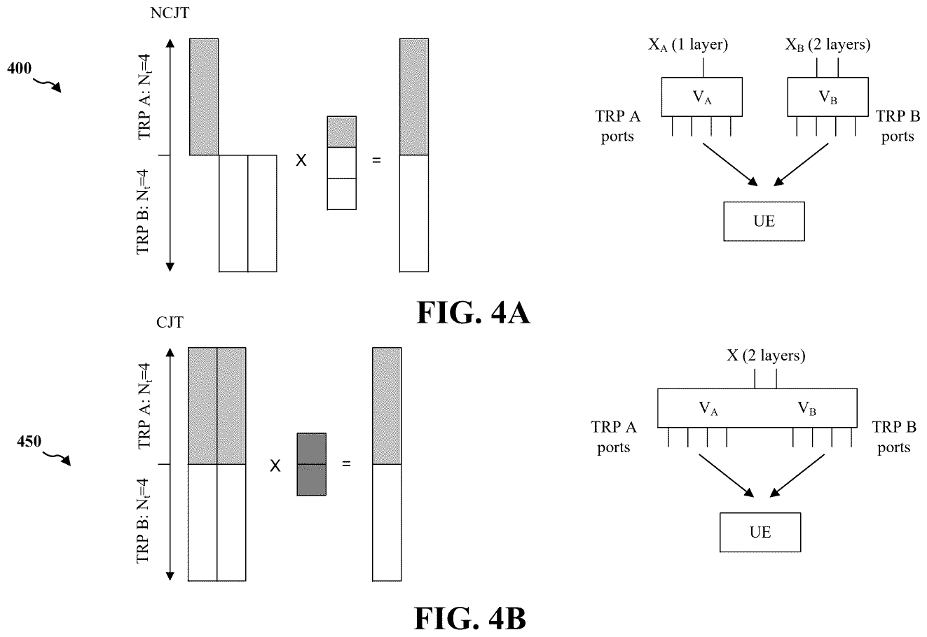

is the number of ports for this TRP, RI^{TRP} is the rank indication for this TRP, and the data (X_{A}, X_{B}) may each have a size of (RI^{TRP}×1). FIG. 4A is a diagram 400 illustrating NCJT with separately pre-coded data on different TRPs. In the example of FIG. 4A,

$${N}_{t}^{TRP}$$

and RI^{TRP} for the first TRP (TRP A) and the second TRP (TRP B) have the size of:

$${N}_{t}^{A} = 4 ,$$

### RI^{A}=1,

$${N}_{t}^{B} = 4 ,$$

and RI^{B}=1. Hence, the pre-coders have the size of: V_{A}:4×1; V_{B}:4×2, and the data has the size of: X_{A}:1×1, X_{B}:2×1.

Wireless communication with multiple TRPs may also transmit a signal through CJT. In CJT, data may be pre-coded jointly for different TRPs. In one example, the precoding of the data may be described as:

$$[ \begin{matrix}{V}_{A} \\ {V}_{B}\end{matrix} ] X = [ \begin{matrix}{V}_{A} X \\ {V}_{B} X\end{matrix} ] \qquad ( 2 )$$

where the subscripts A and B represent different TRPs, the pre-coders (V_{A}, V_{B}) may each have a size of

$$( {N}_{t}^{TRP} \times {RI}^{CJT} ) ,$$

where

$${N}_{t}^{TRP}$$

is the number of ports for this TRP RI^{CJT} is the rank jointly obtained from all the TPRs, and X is data and may have the size of (RI^{CJT}×1). FIG. 4B is a diagram 450 illustrating CJT with jointly pre-coded data on different TRPs. In the example of FIG. 4B,

$${N}_{t}^{TRP}$$

for the first TRP (TRP A) and the second TRP (TRP B) have the size of:

$${N}_{t}^{A} = 4 ,$$

and

$${N}_{t}^{B} = 4 ,$$

and RI^{CJT}=2. Hence, the pre-coders have the size of: V_{A}:4×2; V_{B}:4×2, and the data has the size of: X:2×1.

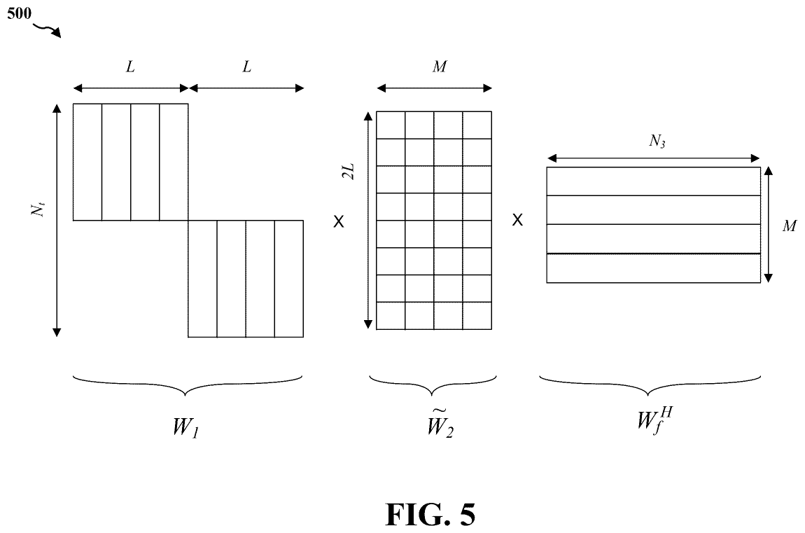

For the eType-II CSI, for each layer, the pre-coder across a number of N₃ sub-bands (PMI-sub-bands) is a Nₜ×N₃ matrix that may be described as:

$$W = {W}_{1} \times {\tilde{W}}_{2} \times {W}_{f}^{H} \qquad ( 3 )$$

where W₁ represents the spatial domain (SD) bases (e.g., DFT bases). W₁ may be layer-common and may be a Nₜ×2 L matrix. In one example, Nₜ=2N₁O₁N₂O₂. N₁ and N₂ may be the numbers of Tx antennas for the respective TRP, and O₁ and O₂ may be the oversampling factors for the respective TRP and may be RRC-configured. W_{f} represents the frequency domain (FD) bases (e.g., DFT bases). W_{f} may be layer-specific and may be a M×N₃ matrix. M is the number of FD bases and may be rank-pair specific. For example, M₁=M₂ for rank={1,2}, and M₃=M₄ for rank={3,4}. M₁ or M₃ may be RRC-configured. Coefficients \tilde{W}₂ may be layer-specific and may be a 2L×M matrix. For each layer, up to Ko non-zero coefficients may be reported (K₀ may be RRC-configured). Across all layers, up to 2K₀ non-zero coefficients may be reported. Unreported coefficients may be set to zeros. FIG. 5 is a diagram 500 illustrating a pre-coder W for single layer. As shown in FIG. 5, the pre-coder W is a product of W₁, \tilde{W}₂, and

$${W}_{f}^{H} . {W}_{1}$$

may be a Nₜ×2 L matrix, \tilde{W}₂ may be a 2L×M matrix, and W_{f} may be a M×N₃ matrix.

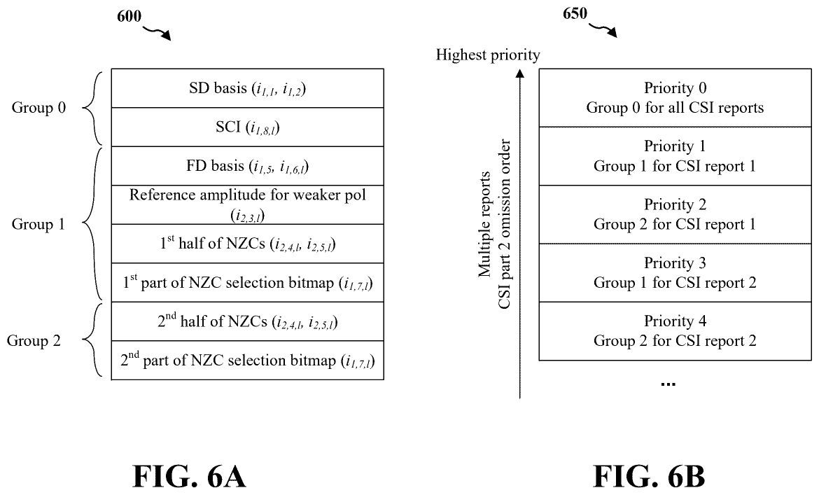

For CSI packing, its part 2 (i.e., \tilde{W}₂) may have variable payload size (depending on the rank), and it may be wasteful if the base station always assumes the maximum payload size associated with the highest rank (e.g., rank-4) to allocate PUSCH resources for the CSI report. The CSI part 2 of one single report may be divided into different groups (e.g., groups 0, 1, and 2). FIG. 6A is a diagram 600 illustrating CSI packing for a single CSI report. As shown in FIG. 6A, the contents of the CSI part 2 of one single report may be divided into groups 0, 1, and 2.

Across multiple reports, the priorities of the group payloads may depend on the group number and the report number. FIG. 6B is a diagram 650 illustrating the CSI omission order for multiple CSI reports in one configuration. As shown in FIG. 6B, in one example, the group 0 payloads may be packed together and may have the highest priority (priority 0, lastly omitted). Groups 1 and 2 payloads may have a lower priority, such as priority 1, 2, . . . , 2Nᵣₑₚₒᵣₜ−1, 2Nᵣₑₚₒᵣₜ, where Nᵣₑₚₒᵣₜ represents the total number of CSI reports.

A CJT transmission may go through multiple TRPs located at the same site (intra-site TRPs) or distributed on different sites (inter-site TRPs). The intra-site TRPs may further include TRPs with the same orientation and TRPs with different orientations. For CJT with independent FD bases for each TRP, the pre-coder for the CJT (Mode 1 codebook) may be described as (for one layer):

$$[ \begin{matrix}{W}^{TRP \# A} \\ {W}^{TRP \# B}\end{matrix} ] = [ \begin{matrix}{W}_{1 , A} \times {\tilde{W}}_{2 , A} \times {W}_{f , A}^{H} \\ {W}_{1 , B} \times {\tilde{W}}_{2 , B} \times {W}_{f , B}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} & 0 \\ 0 & {\tilde{W}}_{2 , B}\end{matrix} ] \times [ \begin{matrix}{W}_{f , A}^{H} \\ {W}_{F , B}^{H}\end{matrix} ] \qquad ( 4 )$$

For CJT with joint FD bases for the TRPs (FD-joint), the pre-coder for the CJT (Mode 2 codebook) may be described as (for one layer):

$$[ \begin{matrix}{W}^{TRP \# A} \\ {W}^{TRP \# B}\end{matrix} ] = [ \begin{matrix}{W}_{1 , A} \times {\tilde{W}}_{2 , A} \times {W}_{f , A}^{H} \\ {W}_{1 , B} \times {\tilde{W}}_{2 , B} \times {W}_{f , B}^{H}\end{matrix} ] = [ \begin{matrix}{W}_{1 , A} & 0 \\ 0 & {W}_{1 , B}\end{matrix} ] \times [ \begin{matrix}{\tilde{W}}_{2 , A} \\ {\tilde{W}}_{2 , B}\end{matrix} ] \times {W}_{f}^{H} \qquad ( 5 )$$

FD basis selection (W_{f}) may be layer-specific. For each layer, the strongest coefficient (SC) may be aligned at FD basis #0. For layer l, the FD basis index of the strongest coefficient (SC) before the index remapping (e.g., index 2 in diagram 710) may be denoted as

$${n}_{3 , l}^{( {m}_{l}^{*} )} ( {n}_{3 , l}^{( {m}_{l}^{*} )}$$

is not reported). The FD basis index

$${n}_{3 , l}^{( m )}$$

may be remapped with respect to

$${n}_{3 , l}^{( {m}_{l}^{*} )}$$

as:

$${\tilde{n}}_{3 , l}^{( m )} = ( {n}_{3 , l}^{( m )} - {n}_{3 , l}^{( {m}_{l}^{*} )} ) mod {N}_{3} \qquad ( 6 )$$

such that

$${n}_{3 , l}^{( {m}_{l}^{*} )} = 0$$

after index remapping. m is remapped as:

$$\tilde{m} = ( m - {m}_{l}^{*} ) mod M ,$$

such that

$${\tilde{m}}_{l}^{*} = 0$$

after index remapping. The FD basis indices after the index remapping (i.e.,

$${\tilde{n}}_{3 , l}^{( m )}$$

for \tilde{m}=1, . . . , M−1) may be reported.

For each layer, the FD basis selection may be a direct 1-stage process, or a window-based 2-stage process, depending on the number of PMI sub-bands (i.e., N₃). In one configuration, if N₃≤19, M−1 FD bases from N₃−1 candidate FD bases may be reported via

$$⌈ {log}_{2} ( \begin{matrix}{N}_{3} - 1 \\ M - 1\end{matrix} ) ⌉ bits$$

for each layer. If N₃>19, a starting index for a window-based intermediate set (down-selected from N₃ to 2M) may first be reported via ┌log₂ M┐ bits. The ┌log₂ M┐ bits may represent window starting location Mᵢₙᵢₜᵢₐₗ∈{−2M+1, −2M+2, . . . , 0}. Then, M−1 FD bases from 2M−1 candidate FD bases may be reported via

$$⌈ {log}_{2} ( \begin{matrix}2 M - 1 \\ M - 1\end{matrix} ) ⌉ bits$$

for each layer. FD basis #0 will always be selected as the strongest coefficient is aligned at FD basis #0.

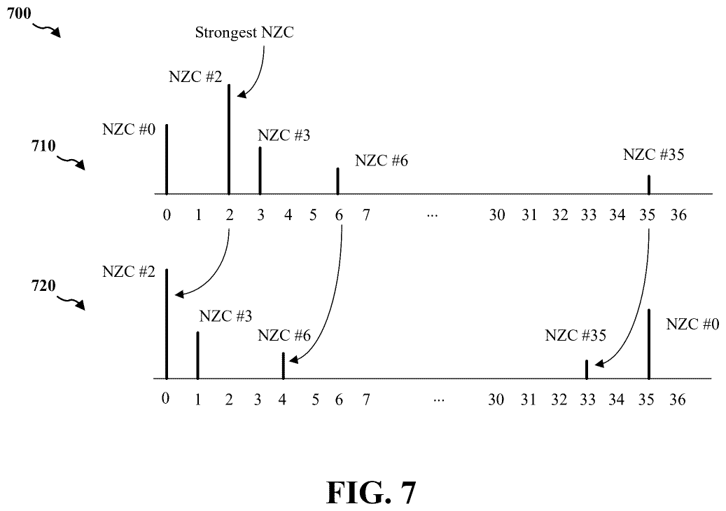

FIG. 7 is a diagram 700 illustrating the FD basis index remapping. In FIG. 7, diagram 710 shows the FD bases before the index remapping, and diagram 720 shows the FD bases after the index remapping. In the example shown in FIG. 7, N₃=37, M=5 (window size 2M=10). The FD basis index of SC before index remapping is

$${n}_{3 , l}^{( {m}_{l}^{*} )} = 2.$$

According to Equation (6), the FD basis index will be remapped as:

$${\tilde{n}}_{3 , l}^{( m )} = ( {n}_{3 , l}^{( m )} - 2 ) mod 37.$$

Accordingly, as shown in diagram 720, the remapping of the FD basis index has an effect of circular shifting the FD bases by the index of the stronger NZC (e.g., 2 in this example) towards the front of the sequence. That is, the FD basis will shift toward the front of the sequence by an amount of the index of the strongest NZC, and the FD basis originally located to the left of the strongest NZC (e.g., FD basis #0 in diagram 710) will be successively placed at the end of the sequence (e.g., after the index remapping, FD basis #0 in diagram 710 is placed at index #35 in diagram 720).

In this disclosure, the term “FD basis” refers to a DFT basis for precoder compression in frequency domain for wireless communication. Each “FD basis” may be associated with one or more precoding matrix indicator (PMI) sub-bands in the frequency domain. A sequence of “FD bases” may refer to a sequence that includes one or more different FD bases. The index of an FD basis in a sequence of FD bases may represent the relative position of the FD basis in the sequence (e.g., index 0 indicating the first FD basis in the sequence). The term “SD basis” refers to a DFT basis for precoder compression in spatial (antenna port) domain for wireless communication. Each “SD basis” may be associated with one or more antenna ports in the spatial domain. A sequence of “SD bases” may refer to a sequence that includes one or more different SD bases. The index of an SD basis in a sequence of SD bases may represent the relative position of the SD basis in the sequence (e.g., index 0 indicating the first SD basis in the sequence). The term “circular shifting” a sequence refers to an operation of rearranging the elements of the sequence by moving the elements along the same direction (either towards the first element or the last element of the sequence) by the same amount, and, during the rearrangement, an element that is moved beyond one end of the sequence is placed on the other end of the sequence, as if the first and the last elements of the sequence are adjacent to form a circle.

After the index remapping, the FD basis may be permuted for coefficient (NZC) ordering. The purpose of the FD permutation may be for UCI packing. A coefficient

$${c}_{{i}_{1} , {m}_{1}}^{( {l}_{1} )}$$

may be assigned a priority of:

$$Prio ( l , i , m ) = 2 L \times rank \times Perm ( m ) + rank \times i + l \qquad ( 7 )$$

where l is the layer index, i is the SD basis index, and m is the FD basis index. A coefficient

$${c}_{{i}_{1} , {m}_{1}}^{( {l}_{1} )}$$

has a lower priority than

$${c}_{{i}_{2} , {m}_{2}}^{( {l}_{2} )}$$

if Prio(l₁, i₁, m₁)>Prio(l₂, i₂, m₂). Since the coefficients that are closer to FD basis 0 are likely to be more significant than those far away from FD basis 0, the permutation function Perm(m) may map the FD basis index m following the order of the corresponding FD components (if selected) according to a sequence of:

$$\{ 0 , {N}_{3} - 1 , 1 , {N}_{3} - 2 , 2 , … \} \qquad ( 8 )$$

Both coefficient and bitmap may be ordered from high to low priority according to the priority defined by Equation (7).

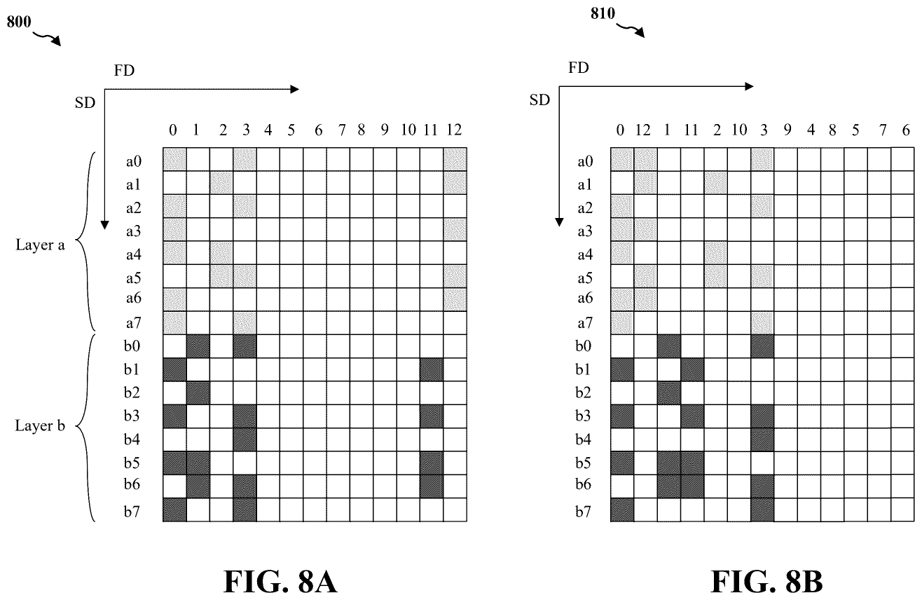

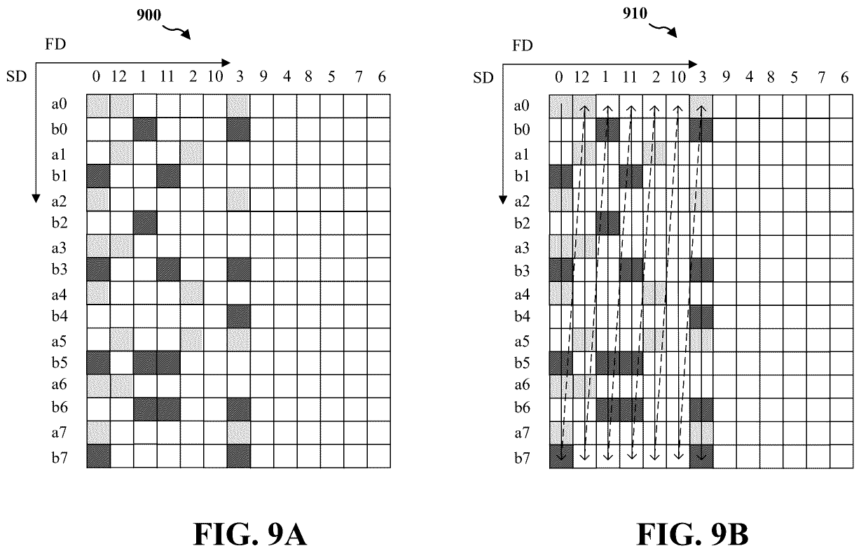

FIGS. 8A, 8B, 9A, and 9B are diagrams illustrating the FD permutation and layer interleaving for coefficient ordering. In the example of FIGS. 8A, 8B, 9A, and 9B, N₃=13 and L=8. FIG. 8A shows a diagram 800 illustrating an original FD bases and SD bases before FD permutation and layer interleaving. FIG. 8B shows a diagram 810 illustrating the FD bases and SD bases after FD permutation. As shown in FIG. 8B, the FD bases are permuted to rearrange the FD bases, and the rearranged FD bases have a sequence of FD bases indices of: {0, 12, 1, 11, 2, . . . }. FIG. 9A shows a diagram 900 illustrating the FD bases and SD bases after layer interleaving. As shown in FIG. 9A, after the layer interleaving. After the layer interleaving, the SD bases have a sequence of SD bases indices of: {a0, b0, a1, b1, a2, b2, . . . }. FIG. 9B shows a diagram 910 illustrating the priority order of the FD bases after the FD permutation and layer interleaving. As shown in FIG. 9B, the priorities of the elements of the matrix will follow a path indicated by the arrow lines shown in FIG. 9B, with the element located on an earlier location of the path has a higher priority than the element on a later location of the path (e.g., the element located on the location (a0, 0) has the highest priority).

The present disclosure provides methods and apparatus for FD basis index remapping for multiple TRPs (mTRP) and for FD permutation for NZC ordering across the multiple TRPs. The methods and apparatus herein presented are applicable to Mode 1 codebook (FD-independent) and Mode 2 codebook (FD-joint) to best share common mechanisms.

For Type-II-CJT CSI with N TRPs, the UE may report N−1 relative FD basis index offsets per layer. The relative FD basis index offsets may be used to determine index remapping for each TRP's FD basis selection, and/or to determine NZC ordering for UCI packing. This disclosure presents a number of aspects for FD basis index remapping for multiple TRPs.

In one aspect, for all N TRPs, each respective FD basis corresponding to the highest priority NZCs are all remapped as index 0. In this option, for different TRPs, the FD basis index after remapping represents different bases.

In another aspect, for the SCI-TRP (i.e., the TRP with the “global” SCI) of the N TRPs is used as the reference TRP. The FD basis corresponding to the highest priority NZC of the reference TRP is remapped as index 0. For the remaining N−1 TRPs, each respective FD basis corresponding to the highest priority NZCs of these TRPs are remapped based on the respective relative FD basis index offsets. In this aspect, for different TRPs, the FD basis index after remapping represents the same bases.

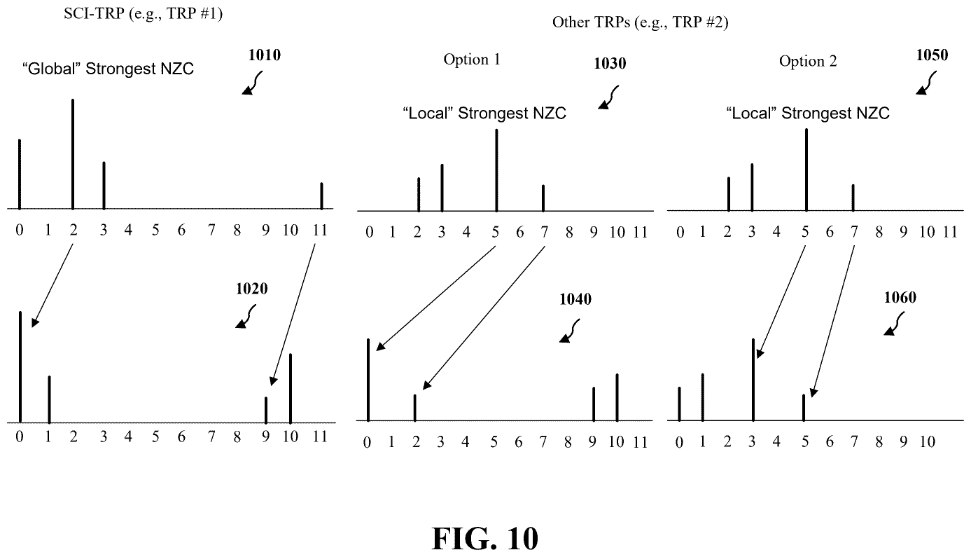

FIG. 10 shows diagrams illustrating the FD basis index remapping for multiple TRPs in accordance with various aspects of the present disclosure. Referring to FIG. 10, for the strongest TRP (SCI-TRP with a global strongest coefficient across TRPs, or a TRP with a strongest power according to \tilde{W}₂, e.g., TRP #1), the FD basis at index location 2 (before remapping) corresponds to its highest priority NZC (i.e., this FD basis is “the highest priority FD basis”), as shown in diagram 1010. For the other TRP (e.g., TRP #2), the FD basis at index location 5 (before remapping) is its highest priority FD basis. The relative FD basis index offset reported for TRP #2 is 3 (i.e., 5−2=3). In some aspects (e.g., option 1 and option 2 shown in FIG. 10), after the FD index remapping, the FD basis corresponding to the “global” strongest NZC is remapped as index 0, as shown in diagrams 1010 and 1020. Accordingly, the FD bases corresponding to other NZCs for the strongest TRP will be circular shifted by the same offset the highest priority FD basis has made. For example, the FD basis at index location 3 in diagram 1010 will be remapped to index location 1 in diagram 1020. The FD bases that were originally located to the left of the highest priority FD basis will be moved to the end of the sequence by the same offset the highest priority FD basis had made. For example, the FD basis that was originally at index location 0 in diagram 1010 is moved to index location 10 in diagram 1020.

Referring to diagrams 1030 and 1040 in FIG. 10, in some aspects (e.g., option 1), the FD bases for TRP #2 (or any of the remaining N−1 TRPs) will be circular shifted so that the FD basis corresponding to the highest priority NZCs for the corresponding TRP are all remapped as index 0. For example, referring to diagram 1030, the FD basis originally located at the index location 5 is the highest priority FD basis for TRP #2. Hence, this FD basis is remapped to index 0, as shown in diagram 1040. Accordingly, all other FD bases in diagram 1030 will be circular shifted by the same offset the highest priority FD basis for TRP #2 had made (e.g., 5). That is, the FD bases originally located at index locations 2, 3, and 7 in diagram 1030 are respectively remapped to index locations 9, 10, and 2 in diagram 1040.

Referring to diagrams 1050 and 1060 in FIG. 10, in some aspects (e.g., option 2), the FD bases for TRP #2 (or any of the remaining N−1 TRPs) will be circular shifted by the same offset the highest priority FD bases for the strongest TRP had made (e.g., 2 in this example). That is, the FD bases originally located at index locations 2, 3, 5, and 7 in diagram 1050 are respectively remapped to index locations 0, 1, 3, and 5 in diagram 1060.

In this disclosure, the relative FD basis index offset for one TRP may refer to the index offset (i.e., the index difference) between the index of the FD basis corresponding to the “local” strongest NZC of this TRP and the index of the FD basis corresponding to the “global” strongest NZC of the strongest TRP. For example, referring to diagrams 1010 and 1030, the relative FD basis index offset for TRP #2 (in diagram 1030) is 3.

In some aspects, the relative FD basis index offsets per layer may be reported according to the modes of the codebook for the TRPs. For mode 1 (FD-independent) codebook, there are a total of N₃ possible offset values (e.g., {0, 1, . . . . N₃−1}). Hence, ┌log₂ N₃┐ bits may be needed to indicate a certain offset for a certain TRP and layer. For mode 2 (FD-joint) codebook, there are a total of M possible offset values (e.g., {0, 1, . . . , M−1} (index of selection), or

$$\{ {n}_{3 , l}^{( 0 )} , {n}_{3 , l}^{( 1 )} , … , {n}_{3 , l}^{( M - 1 )} \}$$

(index of selected FD basis before index remapping), or

$$\{ {\tilde{n}}_{3 , l}^{( 0 )} , {\tilde{n}}_{3 , l}^{( 1 )} , ... , {\tilde{n}}_{3 , l}^{( M - 1 )} \}$$

(index of selected FD basis after index remapping)). Hence, ┌log₂ M┐ bits may be needed to indicate a certain offset for a certain TRP and layer.

The FD basis selection, in some aspects, may be performed according to the modes of the codebook for the TRPs. For mode 1 (FD-independent) codebook, each of the selected M−1 FD bases of each of the N TRPs after index mapping may be report by, for example,

$$⌈ {log}_{2} ( \begin{matrix}{N}_{3} - 1 \\ M - 1\end{matrix} ) ⌉ bits$$

per TRP per layer. For mode 2 (FD-joint) codebook, the selected M−1 FD bases of the strongest TRP after index remapping may be reported by, for example,

$$⌈ {log}_{2} ( \begin{matrix}{N}_{3} - 1 \\ M - 1\end{matrix} ) ⌉ bits$$

per layer. Since other TRP's FD basis selection (whose indices may be different than those of the strongest TRP for the remapping through option 1 shown in FIG. 10) may be derived based on the strongest TRP's FD basis selection and the relative FD basis index offsets, the selected FD bases for other TRPs may not need to be reported. Table 2 summarizes the characterizations (e.g., option 1 and option 2 in FIG. 10) of the FD index remapping in accordance with various aspects of the present disclosure.

TABLE 2
Characteristics of a first option and
a second option for FD index remapping

| | FD index remapping: | FD index remapping: |
|---|---|---|
| | option 1 | option 2 |
| Mode 1 (FD- | Can be different indices across TRPs either | |
| independent) | before or after index remapping | |
| codebook | | |
| Mode 2 (FD-joint) | Before remapping: same | Before remapping: same |
| codebook | indices across TRPs; | indices across TRPs; |
| | After remapping: | After remapping: same |
| | different indices across | indices across TRPs |
| | TRPs. | |

The FD basis selection may be performed based on the number of sub-bands (i.e., N₃) for each TRP. For a small N₃ (e.g., N₃≤19), the FD basis selection mechanism for single TRP (sTRP) may be reused for FD basis selection for multiple TRPs (e.g., directly selecting M−1 FD bases out of N₃−1 FD bases). For example, for mode 1 (FD-independent) codebook, the FD basis selection for one TRP (e.g., the strongest TRP) may be performed via

$$⌈ {log}_{2} ( \begin{matrix}{N}_{3} - 1 \\ M - 1\end{matrix} ) ⌉ \times rank bits ,$$

while the FD basis selections for N−1 remaining TRPs may also be performed via

$$( N - 1 ) \times ⌈ {log}_{2} ( \begin{matrix}{N}_{3} - 1 \\ M - 1\end{matrix} ) ⌉ \times rank bits$$

independently. For a large N₃ (e.g., N₃>19), the FD basis selection may be performed via a two-stage process.

The first stage may be the selection of an FD basis window of size 2M. For example, for mode 1 (FD-independent) codebook, the FD basis window for one TRP (e.g., the strongest TRP) may be performed via ┌log₂ (2M)┐×rank bits, while the FD basis window selection for the remaining N−1 TRPs may be performed via (N−1)×┌log₂ (2M)┐×rank bits independently (the N−1 remaining TRPs' FD basis windows of size 2M will include the offset-related FD basis).

The second stage may be the FD basis selection from the FD basis window of the first stage. For example, for mode 1 (FD-independent) codebook, the second stage FD basis selection for one TRP (e.g., the strongest TRP) may be performed through

$$⌈ {log}_{2} ( \begin{matrix}2 M - 1 \\ M - 1\end{matrix} ) ⌉ \times rank bits ,$$

while the second stage FD basis selection for the N−1 remaining TRPs may be performed through

$$( N - 1 ) \times ⌈ {log}_{2} ( \begin{matrix}2 M - 1 \\ M - 1\end{matrix} ) ⌉ \times rank bits$$

independently.

For mode 1 (FD-independent) codebook, the same number of possible FD bases (e.g.,

$$( \begin{matrix}{N}_{3} - 1 \\ M - 1\end{matrix} )$$

for a small N₃ (e.g., N₃≤19), or

$$( \begin{matrix}2 M - 1 \\ M - 1\end{matrix} )$$

for a large N₃ (e.g., N₃>19)) may be selected for all TRPs. Additionally, for mode 1 (FD-independent) codebook, the location of the FD basis windows may be reported with the same number (e.g., 2M) of possible values for all TRPs, and Mᵢₙᵢₜᵢₐₗ∈{−2M+1, . . . , 0} for the strongest TRP, and Mᵢₙᵢₜᵢₐₗ∈{−2M+1+offset, . . . , offset} for the remaining N−1 TRPs.

The implementation of FD permutation for NZC ordering may depend on which aspect (e.g., a first option or the second option) is used for FD basis index remapping. If the first option is used, the permutation function Perm(m) described in connection with sequence (8) may be used. That is, the permutation function of:

$$Perm ( m ) = min ( 2 {\tilde{n}}_{3 , l}^{( m )} , 2 ( {N}_{3} - {\tilde{n}}_{3 , l}^{( m )} ) - 1 ) \qquad ( 9 )$$

may be used map {0, 1, . . . , N₃−1} to: {0, N₃−1, 1, N₃−2, 2, . . . }, where FD basis #0 is the highest priority FD basis.

If the second option is used, a modified permutation function of:

$$Perm ( m ) = min ( 2 [ ( {\tilde{n}}_{3 , l}^{( m )} - offset ) mod {N}_{3} ] , 2 ( {N}_{3} - [ ( {\tilde{n}}_{3 , l}^{( m )} - offset ) mod {N}_{3} ] ) - 1 ) \qquad ( 10 )$$

may be used to map {0, 1, . . . , offset, . . . , N₃−1} to {offset, offset−1, offset+1, offset−2, offset+2, . . . }, where the FD basis #offset is the highest priority FD basis.

For NZC priority determination within the same TRP, the priority determination mechanism described by Equation (7) may be used. NZC priority determination for UCI packing across multiple TRPs may be implemented in several ways. In the first implementation, the priority of a coefficient may be:

$$Prio ( l , i , m ) = 2 {L}_{tot} \cdot rank \cdot Perm ( m ) + rank \cdot i + l \qquad ( 11 )$$

where SD basis index i=0, . . . , 2Lₜₒₜ−1, and Lior is the total SD bases selected across all TRPs. In Equation (11), the FD index is the most significant factor that affects the priority. In the second implementation, the priority of a coefficient may be:

$$Prio ( l , i , m ) = {\sum }_{k = 1}^{n - 1} 2 {L}_{k} \cdot rank \cdot {M}_{k} + 2 {L}_{n} \cdot rank \cdot Perm ( m ) + rank \cdot i + l \qquad ( 12 )$$

In Equation (12) above, Mₖ is the number of FD bases selected for the TRP k (the value of Mₖ may be either TRP-common or TRP-specific),

$${\sum }_{k = 1}^{n - 1} 2 {L}_{k} \cdot rank \cdot {M}_{k}$$

corresponds to all coefficient of TRP k=1, . . . , n−1, SD basis index i=0, . . . , 2Lₙ−1 is for a certain TRP n, and Lₙ is the number of SD bases selected for TRP n. In Equation (12), the TRP dimension is the most significant factor that affects the priority.

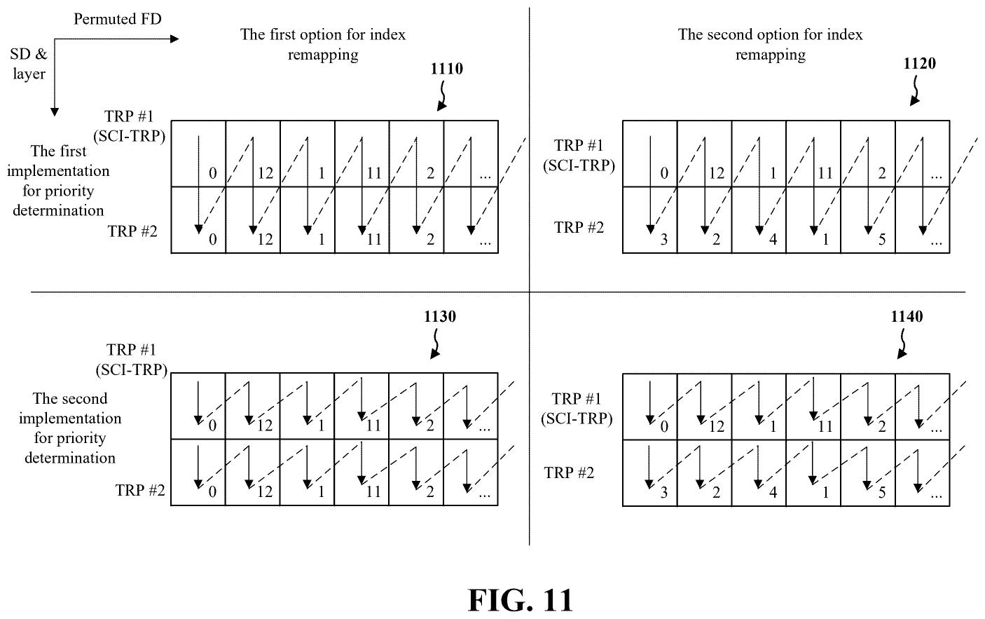

FIG. 11 shows diagrams illustrating the NZC ordering across multiple TRPs in accordance with various aspects of the present disclosure. In FIG. 11, diagram 1110 shows the NZC ordering result using the first option for FD index remapping and using the first implementation (i.e., Equation (11)) for priority determination. Diagram 1120 shows the NZC ordering result using the second option for FD index remapping and using the first implementation (i.e., Equation (11)) for priority determination. Diagram 1130 shows the NZC ordering result using the first option for FD index remapping and using the second implementation (i.e., Equation (12)) for priority determination. Diagram 1140 shows the NZC ordering result using the second option for FD index remapping and using the second implementation (i.e., Equation (12)) for priority determination. The arrow paths in each of diagrams 1110, 1120, 1130, and 1140 show the NZC ordering for two TRPs (TRP #1, which is the strongest TRP, and TRP #2), with the elements located on an earlier location of an arrow path has a higher priority than the element on a later location of the path.

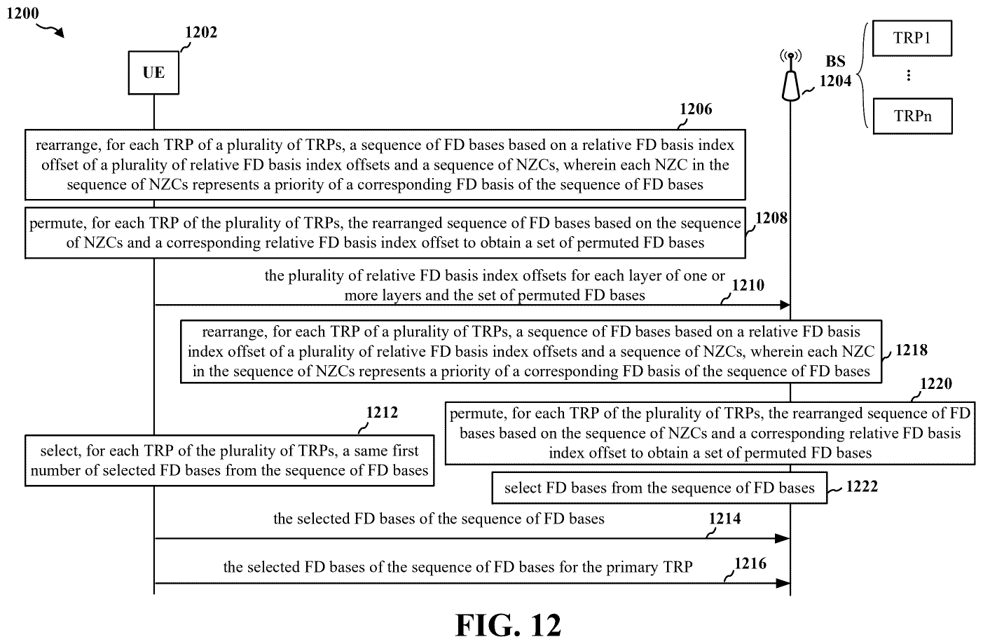

FIG. 12 is a call flow diagram 1200 illustrating a method of wireless communication in accordance with various aspects of this present disclosure. Although aspects are described for a base station 1204, the aspects may be performed by a base station in aggregation and/or by one or more components of a base station 1204 (e.g., such as a CU 110, a DU 130, and/or an RU 140). As illustrated, the base station 1204 may be associated with or include multiple TRPs (TRP1, . . . , TRPn). The multiple TRPs may include aspects described in connection with, for example, FIGS. 4A, 4B, 10, and 11.

As shown in FIG. 12, a UE 1202 may, at 1206, rearrange, for each TRP of a plurality of TRPs, a sequence of FD bases based on a relative FD basis index offset of a plurality of relative FD basis index offsets and a sequence of NZCs. Each NZC in the sequence of NZCs may represent a priority of a corresponding FD basis of the sequence of FD bases. For example, the sequence of FD bases may be rearranged according to the first option or the second option, as described in connection with FIG. 10.

At 1208, the UE 1202 may permute, for each TRP of the plurality of TRPs, the rearranged sequence of FD bases based on the sequence of NZCs and a corresponding relative FD basis index offset to obtain a set of permuted FD bases. For example, the rearranged sequence of FD bases may be permuted according to one of Equations (9) or (10) based on the priority of the NZCs, and the priority of the NZCs may be determined according to one of the priority functions (11) or (12).

At 1210, the UE 1202 may transmit the plurality of relative FD basis index offsets for each layer of one or more layers and the set of permuted FD bases to the base station 1204.

At 1212, the UE 1202 may select, for each TRP of the plurality of TRPs, a same first number of selected FD bases from the sequence of FD bases.

In some aspects, at 1214, the UE 1202 may transmit the selected FD bases of the sequence of FD bases to the base station 1204.

In some aspects, at 1216, the UE 1202 may transmit the selected FD bases of the sequence of FD bases for the primary TRP to the base station 1204.

In some aspects, at 1218, the base station 1204 may rearrange, for each TRP of a plurality of TRPs, a sequence of FD bases based on a relative FD basis index offset of a plurality of relative FD basis index offsets and a sequence of NZCs. Each NZC in the sequence of NZCs may represent a priority of a corresponding FD basis of the sequence of FD bases. For example, the sequence of FD bases may be rearranged according to the first option or the second option, as described in connection with FIG. 10.

In some aspects, at 1220, the base station 1204 may permute, for each TRP of the plurality of TRPs, the rearranged sequence of FD bases based on the sequence of NZCs and a corresponding relative FD basis index offset to obtain a set of permuted FD bases. For example, the rearranged sequence of FD bases may be permuted according to one of Equations (9) or (10) based on the priority of the NZCs, and the priority of the NZCs may be determined according to one of the priority functions (11) or (12).

In some aspects, at 1222, the base station 1204 may select one or more FD bases from the sequence of FD bases for each TRP of the plurality of TRPs.

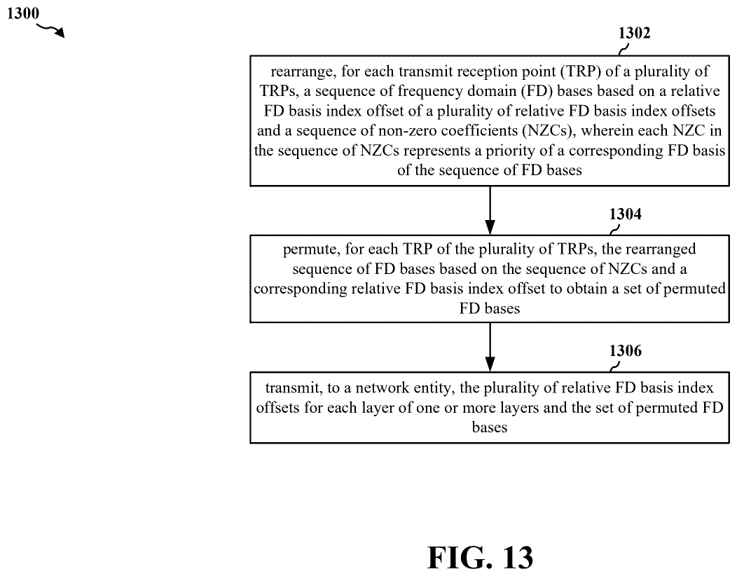

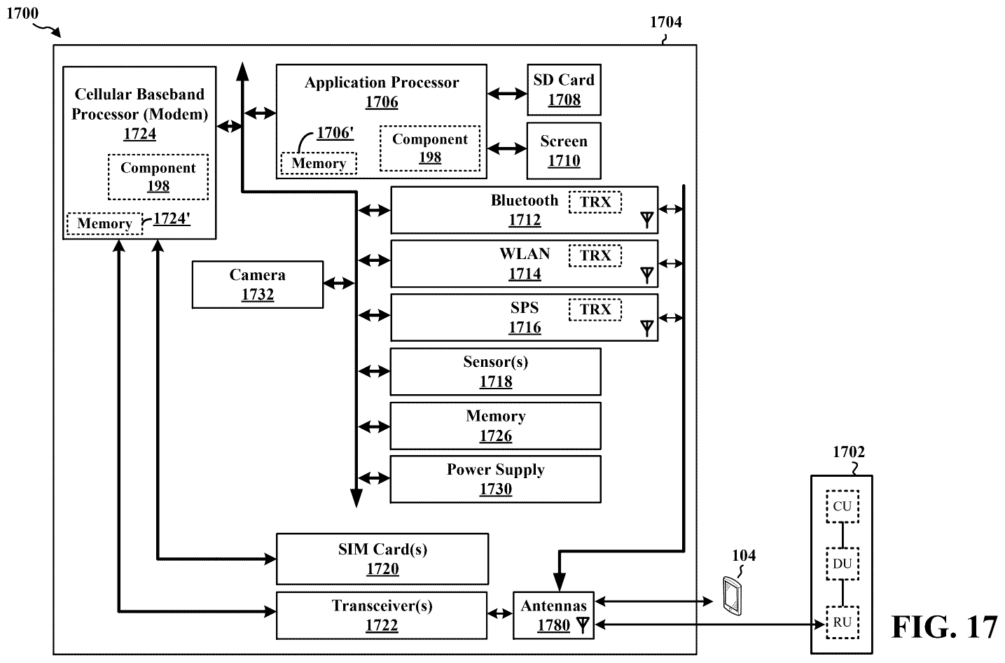

FIG. 13 is a flowchart 1300 illustrating methods of wireless communication at a UE in accordance with various aspects of the present disclosure. The method may be performed by a UE. The UE may be the UE 104, 350, 1202, or the apparatus 1704 in the hardware implementation of FIG. 17. The methods provide FD basis index remapping and FD permutation for NZC ordering for multiple TRPs and improve the efficiency of wireless communication with multiple TRPs.

As shown in FIG. 13, at 1302, the UE may rearrange, for each TRP of a plurality of TRPs, a sequence of FD bases based on a relative FD basis index offset of a plurality of relative FD basis index offsets and a sequence of NZCs. Each NZC in the sequence of NZCs may represent a priority of a corresponding FD basis of the sequence of FD bases. FIGS. 10, 11, and 12 and Equations (6)-(12) illustrate various aspects of the steps in connection with flowchart 1300. For example, referring to FIG. 12, the UE 1202 may rearrange, at 1206, for each TRP of a plurality of TRPs, a sequence of FD bases based on a relative FD basis index offset of a plurality of relative FD basis index offsets and a sequence of NZCs. For example, the sequence of FD bases may be rearranged according to the first option or the second option, as described in connection with FIG. 10. Further, step 1302 may be performed by the FD basis indication component 198.

At 1304, the UE may permute, for each TRP of the plurality of TRPs, the rearranged sequence of FD bases based on the sequence of NZCs and a corresponding relative FD basis index offset to obtain a set of permuted FD bases. For example, referring to FIG. 12, the UE 1202 may permute, at 1208, for each TRP of the plurality of TRPs, the rearranged sequence of FD bases based on the sequence of NZCs and a corresponding relative FD basis index offset to obtain a set of permuted FD bases. For example, the rearranged sequence of FD bases may be permuted according to one of Equations (9) or (10) based on the priority of the NZCs, and the priority of the NZCs may be determined according to one of the priority functions (11) or (12). Further, step 1304 may be performed by the FD basis indication component 198.

At 1306, the UE may transmit, to a network entity, the plurality of relative FD basis index offsets for each layer of one or more layers and the set of permuted FD bases. The network entity may be a base station, or a component of a base station, in the access network of FIG. 1 or a core network component (e.g., base station 102, 310; base station 1204; or the network entity 1702 in the hardware implementation of FIG. 17). For example, referring to FIG. 12, the UE 1202 may transmit, at 1210, to a network entity (base station 1206), the plurality of relative FD basis index offsets for each layer of one or more layers and the set of permuted FD bases. Further, step 1306 may be performed by the FD basis indication component 198.

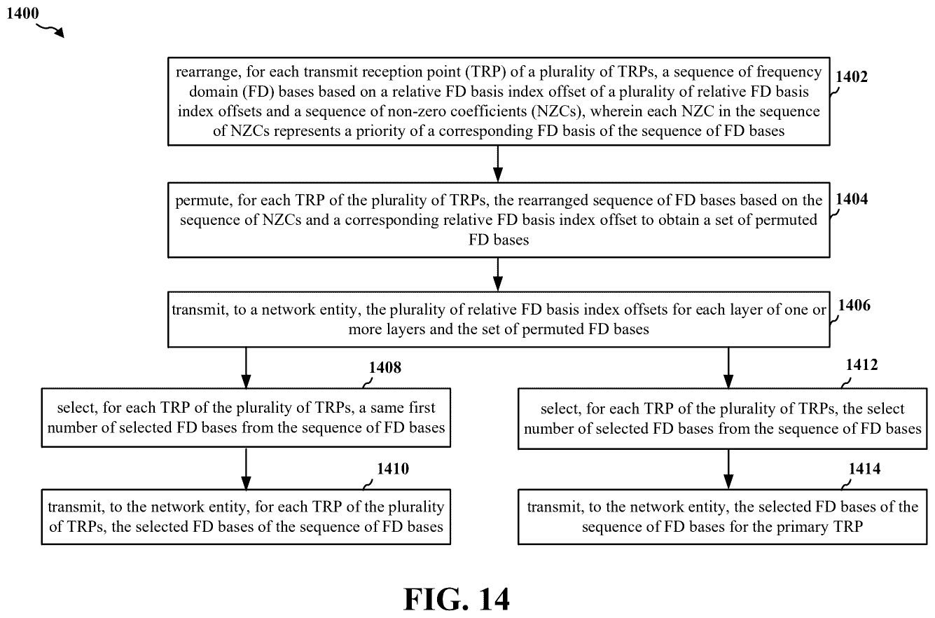

FIG. 14 is a flowchart 1400 illustrating methods of wireless communication at a UE in accordance with various aspects of the present disclosure. The method may be performed by a UE. The UE may be the UE 104, 350, 1202, or the apparatus 1704 in the hardware implementation of FIG. 17. The methods provide FD basis index remapping and FD permutation for NZC ordering for multiple TRPs and enhance the efficiency of wireless communication with multiple TRPs.

As shown in FIG. 14, at 1402, the UE may rearrange, for each TRP of a plurality of TRPs, a sequence of FD bases based on a relative FD basis index offset of a plurality of relative FD basis index offsets and a sequence of NZCs. Each NZC in the sequence of NZCs may represent a priority of a corresponding FD basis of the sequence of FD bases. FIGS. 10, 11, and 12 and Equations (6)-(12) illustrates various aspects of the steps in connection with flowchart 1400. For example, referring to FIG. 12, the UE 1202 may rearrange, at 1206, for each TRP of a plurality of TRPs, a sequence of FD bases based on a relative FD basis index offset of a plurality of relative FD basis index offsets and a sequence of NZCs. For example, the sequence of FD bases may be rearranged according to the first option or the second option, as described in connection with FIG. 10. Further, step 1402 may be performed by the FD basis indication component 198.

At 1404, the UE may permute, for each TRP of the plurality of TRPs, the rearranged sequence of FD bases based on the sequence of NZCs and a corresponding relative FD basis index offset to obtain a set of permuted FD bases. For example, referring to FIG. 12, the UE 1202 may permute, at 1208, for each TRP of the plurality of TRPs, the rearranged sequence of FD bases based on the sequence of NZCs and a corresponding relative FD basis index offset to obtain a set of permuted FD bases. For example, the rearranged sequence of FD bases may be permuted according to one of Equations (9) or (10) based on the priority of the NZCs, and the priority of the NZCs may be determined according to one of the priority functions (11) or (12). Further, step 1404 may be performed by the FD basis indication component 198.

At 1406, the UE may transmit, to a network entity, the plurality of relative FD basis index offsets for each layer of one or more layers and the set of permuted FD bases. The network entity may be a base station, or a component of a base station, in the access network of FIG. 1 or a core network component (e.g., base station 102, 310; base station 1204; or the network entity 1702 in the hardware implementation of FIG. 17). For example, referring to FIG. 12, the UE 1202 may transmit, at 1210, to a network entity (base station 1206), the plurality of relative FD basis index offsets for each layer of one or more layers and the set of permuted FD bases. Further, step 1406 may be performed by the FD basis indication component 198.

In some aspects, rearranging the sequence of FD bases may include circular shifting the sequence of FD bases corresponding to a primary TRP of the plurality of TRPs according to the relative FD basis index offset corresponding to the primary TRP to place an FD basis corresponding to a highest priority NZC of the sequence of NZCs to a first place at the sequence of the FD bases. For example, referring to FIG. 10, rearranging the sequence of FD bases may include circular shifting the sequence of FD bases (the sequence of FD bases in diagram 1010) corresponding to a primary TRP (e.g., the strongest TRP (TRP #1) in diagram 1010) of the plurality of TRPs according to the relative FD basis index offset corresponding to the primary TRP to place an FD basis corresponding to a highest priority NZC of the sequence of NZCs (e.g., the FD basis corresponding to the “Global” strongest NZC in diagram 1010) to a first place at the sequence of the FD bases (e.g., the FD basis corresponding to the “Global” strongest NZC in diagram 1010 is placed to the first place of the sequence in diagram 1020).

In some aspects, the plurality of TRPs may further include one or more secondary TRPs. Rearranging the sequence of FD bases may include circular shifting, for each secondary TRP of the one or more secondary TRPs, the sequence of FD bases corresponding to the secondary TRP to place the FD basis corresponding to the highest priority NZC of the sequence of NZCs for the corresponding secondary TRP to the first place at the sequence of the FD bases. For example, referring to FIG. 10, the plurality of TRPs may further include one or more secondary TRPs (e.g., TRP #2 in FIG. 10). Rearranging the sequence of FD bases may include circular shifting, for each secondary TRP of the one or more secondary TRPs, the sequence of FD bases corresponding to the secondary TRP to place the FD basis corresponding to the highest priority NZC of the sequence of NZCs (e.g., the FD basis corresponding to “local” strongest NZC in diagram 1030) to the first place at the sequence of the FD bases (i.e., the FD basis corresponding to the “local” strongest NZC in diagram 1030 is placed to the first place at the sequence in diagram 1040).). Each of the one or more secondary TRPs may have its highest priority NZC, and each highest priority NZC may correspond to one secondary TRP of the one or more secondary TRPs.

In some aspects, permuting, for each TRP of the plurality of TRPs, the rearranged sequence of FD bases may include permuting, for each TRP of the plurality of TRPs, the rearranged sequence of FD bases corresponding to the TRP based on a position of each FD basis in the rearranged sequence of FD bases with respect to the first place of the sequence. For example, referring to FIGS. 8A, 8B, and sequence (8), the rearranged sequence of FD bases may be permuted from an original index sequence of {0, 1, 2, . . . , 12}, as shown in FIG. 8A, to a permuted index sequence of {1, 12, 1, 11, . . . , 6}, as shown in FIG. 8B, according to the sequence (8).

In some aspects, the plurality of TRPs may further include one or more secondary TRPs. Rearranging the sequence of FD bases may include circular shifting, for each secondary TRP of the one or more secondary TRPs, the sequence of FD bases corresponding to the secondary TRP by the relative FD basis index offset corresponding to the primary TRP. For example, referring to FIG. 10, the plurality of TRPs may further include one or more secondary TRPs (e.g., TRP #2 in FIG. 10). Rearranging the sequence of FD bases may include circular shifting, for each secondary TRP of the one or more secondary TRPs, the sequence of FD bases corresponding to the secondary TRP by the relative FD basis index offset corresponding to the primary TRP (the sequence of FD bases in diagram 1050 is rearranged, by circular shifting by the relative FD basis index offset of 2, to the sequence of FD bases in diagram 1060).

In some aspects, permuting, for each TRP of the plurality of TRPs, the rearranged sequence of FD bases may include permuting, for the primary TRP of the plurality of TRPs, the rearranged sequence of FD bases corresponding to the primary TRP based on a position of each FD basis in the sequence of FD bases with respect to the first place of the sequence; and permuting, for each secondary TRP of the one or more secondary TRPs, the rearranged sequence of FD bases corresponding to the secondary TRP based on the relative FD basis index offset corresponding to the secondary TRP. For example, referring to the description in connection with FIG. 10 and Equation (10), for the primary TRP (e.g., the strongest TRP (TRP #1) in FIG. 10), the rearranged sequence of FD bases may be permuted based on a position of each FD basis in the sequence of FD bases with respect to the first place of the sequence (index 0 in diagram 1020). For each secondary TRP of the one or more secondary TRPs (e.g., TRP #2 in FIG. 10), the rearranged sequence of FD bases may be permuted on the relative FD basis index offset corresponding to the secondary TRP (e.g., the permutation is performed based on Equation (10), with the value of “offset” in Equation (10) being 2 in the example of diagrams 1050 and 1060 in FIG. 10).

In some aspects, FD bases for different TRPs may be independently selected, and each relative FD basis index offset may be less than or equal to a number of FD bases in the sequence of FD bases.

At 1408, the UE may select, for each TRP of the plurality of TRPs, a same first number of selected FD bases from the sequence of FD bases. At 1410, the UE may transmit, to the network entity, for each TRP of the plurality of TRPs, the selected FD bases of the sequence of FD bases. For example, referring to FIG. 12, the UE 1202 may select, at 1212, select, for each TRP of the plurality of TRPs, the same first number of selected FD bases from the sequence of FD bases. The UE may transmit, at 1214, the selected FD bases of the sequence of FD bases to the network entity (base station 1204). Further, steps 1408 and 1410 may be performed by the FD basis indication component 198.

In some aspects, selecting the first number of selected FD bases from the sequence of FD bases may include selecting, in response to the number of FD bases in the sequences of FD bases being less than or equal to a threshold, the first number of FD bases from the sequence of FD bases for each TRP in the plurality of TRPs; and selecting, in response to the number of FD bases in the sequence of FD bases being greater than the threshold, a subset of FD bases from the sequence of FD bases for each TRP of the plurality of TRPs, and select the first number of FD bases from the subset of FD bases for each TRP in the plurality of TRPs. For example, referring to FIG. 12, when UE 1202, selects, at 1212, a same first number of selected FD bases from the sequence of FD bases, the UE 1202 may select, in response to the number of FD bases in the sequences of FD bases being less than or equal to a threshold, the first number of FD bases from the sequence of FD bases for each TRP in the plurality of TRPs; and select, in response to the number of FD bases in the sequence of FD bases being greater than the threshold, a subset of FD bases from the sequence of FD bases for each TRP of the plurality of TRPs, and select the first number of FD bases from the subset of FD bases for each TRP in the plurality of TRPs.

In some aspects, FD bases for at least two TRPs of the plurality of TRPs may be selected (e.g., commonly selected), and each relative FD basis index offset may have a second number of candidate values. The second number of candidate values may equal to a select number of selected FD bases. For example, for CJT with multiple TRPs, the FD bases for least two TRPs of the plurality of TRPs may be selected (e.g., commonly selected), and each relative FD basis index offset may have a second number of candidate values.

At 1412, the UE may select, for each TRP of the plurality of TRPs, the select number of selected FD bases from the sequence of FD bases. At 1414, the UE may transmit, to the network entity, the selected FD bases of the sequence of FD bases for the primary TRP. For example, referring to FIG. 12, at 1212, the UE 1202 may select, for each TRP of the plurality of TRPs, the select number (e.g., the first number) of selected FD bases from the sequence of FD bases, and at 1216, the UE 1202 may transmit the selected FD bases of the sequence of FD bases for the primary TRP to the network entity (base station 1204). Further, steps 1412 and 1414 may be performed by the FD basis indication component 198.

In some aspects, permuting the rearranged sequence of FD bases may include permuting the rearranged sequences of FD bases for two or more TRPs of the plurality of TRPs based on a priority of each FD basis of the sequences of FD bases. The FD bases in the first location of the sequence of FD bases may have a higher priority than the FD bases in a second location of the sequence of FD bases succeeding the first location for any of the one or more TRPs. For example, referring to diagrams 1110 and 1120 in FIG. 11, the rearranged sequences of FD bases for two or more TRPs of the plurality of TRPs may be permuted based on a priority of each FD basis of the sequences of FD bases, so that, after the permutation, the FD bases in the first location of the sequence of FD bases may have a higher priority than the FD bases in a second location of the sequence of FD bases succeeding the first location for any of the one or more TRPs (e.g., in diagrams 1110 and 1120, a FD basis in the first location of the sequence of FD bases in TRP #1 for TRP #2 has a higher priority than a FD basis in a second location of the sequence of FD bases succeeding the first location in TRP #1 or TRP #2).

In some aspects, permuting the rearranged sequence of FD bases may include permuting the rearranged sequences of FD bases for two or more TRPs of the plurality of TRPs based on a priority of each FD basis of the sequences of FD bases. The FD bases for a first TRP of the two or more TRPs may all have a higher priority than the FD bases for a second TRP of the two or more TRPs succeeding the first TRP. For example, referring to diagrams 1130 and 1140 in FIG. 11, the rearranged sequences of FD bases for two or more TRPs of the plurality of TRPs may be permuted based on a priority of each FD basis of the sequences of FD bases, so that, after the permutation, the FD bases for a first TRP of the two or more TRPs may all have a higher priority than the FD bases for a second TRP of the two or more TRPs succeeding the first TRP (e.g., in diagrams 1130 and 1140, a FD basis in TRP #1 has a higher priority than a FD basis in TRP #2).

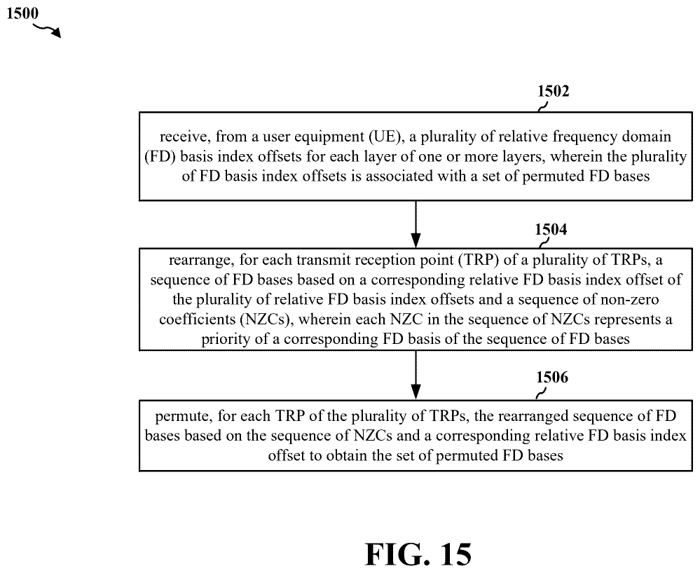

FIG. 15 is a flowchart 1500 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 1702 in the hardware implementation of FIG. 17). The methods provide FD basis index remapping and FD permutation for NZC ordering for multiple TRPs and improve the efficiency of wireless communication with multiple TRPs.

As shown in FIG. 15, at 1502, the network entity may receive, from a UE, a plurality of relative FD basis index offsets for each layer of one or more layers. The plurality of FD basis index offsets may be associated with a set of permuted FD bases. The UE may be the UE 104, 350, 1202, or the apparatus 1704 in the hardware implementation of FIG. 17. FIGS. 10, 11, and 12 and Equation (6)-(12) illustrate various aspects of the steps in connection with flowchart 1500. For example, referring to FIG. 12, the network entity (base station 1204) may receive, at 1210, from a UE 1202, a plurality of relative FD basis index offsets for each layer of one or more layers. The plurality of FD basis index offsets may be associated with a set of permuted FD bases. Further, step 1502 may be performed by the FD basis reception component 199.

At 1504, the network entity may rearrange, for each TRP of a plurality of TRPs, a sequence of FD bases based on a corresponding relative FD basis index offset of the plurality of relative FD basis index offsets and a sequence of NZCs. Each NZC in the sequence of NZCs represents a priority of a corresponding FD basis of the sequence of FD bases. For example, referring to FIG. 12, the network entity (base station 1204) may rearrange, at 1218, for each TRP of a plurality of TRPs, a sequence of FD bases based on a relative FD basis index offset of a plurality of relative FD basis index offsets and a sequence of NZCs. For example, the sequence of FD bases may be rearranged according to the first option or the second option, as described in connection with FIG. 10. Further, step 1504 may be performed by the FD basis reception component 199.

At 1506, the network entity may permute, for each TRP of the plurality of TRPs, the rearranged sequence of FD bases based on the sequence of NZCs and a corresponding relative FD basis index offset to obtain the set of permuted FD bases. For example, referring to FIG. 12, the network entity (base station 1204) may permute, at 1220, for each TRP of the plurality of TRPs, the rearranged sequence of FD bases based on the sequence of NZCs and a corresponding relative FD basis index offset to obtain a set of permuted FD bases. For example, the rearranged sequence of FD bases may be permuted according to one of Equations (9) or (10) based on the priority of the NZCs, and the priority of the NZCs may be determined according to one of the priority functions (11) or (12). Further, step 1506 may be performed by the FD basis reception component 199.

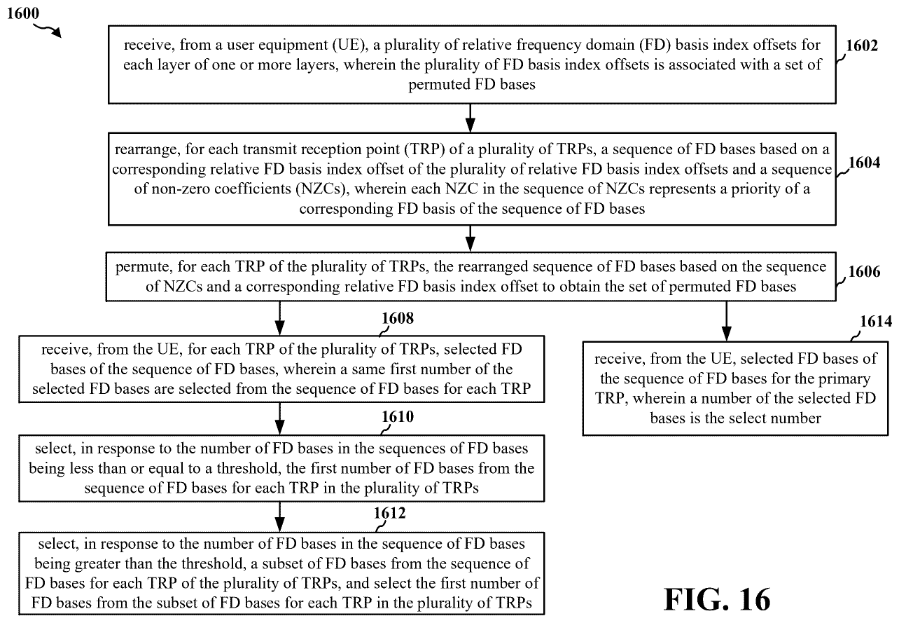

FIG. 16 is a flowchart 1600 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1204; or the network entity 1702 in the hardware implementation of FIG. 17). The methods provide FD basis index remapping and FD permutation for NZC ordering for multiple TRPs and improve the efficiency of wireless communication with multiple TRPs.

As shown in FIG. 16, at 1602, the network entity may receive, from a UE, a plurality of relative FD basis index offsets for each layer of one or more layers. The plurality of FD basis index offsets may be associated with a set of permuted FD bases. The UE may be the UE 104, 350, 1202, or the apparatus 1704 in the hardware implementation of FIG. 17. FIGS. 10, 11, 12 and Equations (6)-(12) illustrate various aspects of the steps in connection with flowchart 1500. For example, referring to FIG. 12, the network entity (base station 1204) may receive, at 1210, from a UE 1202, a plurality of relative FD basis index offsets for each layer of one or more layers. The plurality of FD basis index offsets may be associated with a set of permuted FD bases. Further, step 1602 may be performed by the FD basis reception component 199.

At 1604, the network entity may rearrange, for each TRP of a plurality of TRPs, a sequence of FD bases based on a corresponding relative FD basis index offset of the plurality of relative FD basis index offsets and a sequence of NZCs. Each NZC in the sequence of NZCs represents a priority of a corresponding FD basis of the sequence of FD bases. For example, referring to FIG. 12, the network entity (base station 1204) may rearrange, at 1218, for each TRP of a plurality of TRPs, a sequence of FD bases based on a relative FD basis index offset of a plurality of relative FD basis index offsets and a sequence of NZCs. For example, the sequence of FD bases may be rearranged according to the first option or the second option, as described in connection with FIG. 10. Further, step 1604 may be performed by the FD basis reception component 199.

At 1606, the network entity may permute, for each TRP of the plurality of TRPs, the rearranged sequence of FD bases based on the sequence of NZCs and a corresponding relative FD basis index offset to obtain the set of permuted FD bases. For example, referring to FIG. 12, the network entity (base station 1204) may permute, at 1220, for each TRP of the plurality of TRPs, the rearranged sequence of FD bases based on the sequence of NZCs and a corresponding relative FD basis index offset to obtain a set of permuted FD bases. For example, the rearranged sequence of FD bases may be permuted according to one of Equations (9) or (10) based on the priority of the NZCs, and the priority of the NZCs may be determined according to one of the priority functions (11) or (12). Further, step 1606 may be performed by the FD basis reception component 199.

In some aspects, rearranging the sequence of FD bases may include circular shifting the sequence of FD bases corresponding to a primary TRP of the plurality of TRPs according to the relative FD basis index offset corresponding to the primary TRP to place an FD basis corresponding to a highest priority NZC of the sequence of NZCs to a first place at the sequence of the FD bases. For example, referring to FIG. 10, rearranging the sequence of FD bases may include circular shifting the sequence of FD bases (the sequence of FD bases in diagram 1010) corresponding to a primary TRP (e.g., the strongest TRP (TRP #1) in diagram 1010) of the plurality of TRPs according to the relative FD basis index offset corresponding to the primary TRP to place an FD basis corresponding to a highest priority NZC of the sequence of NZCs (e.g., the FD basis corresponding to the “Global” strongest NZC in diagram 1010) to a first place at the sequence of the FD bases (e.g., the FD basis corresponding to the “Global” strongest NZC in diagram 1010 is placed to the first place of the sequence in diagram 1020).

In some aspects, the plurality of TRPs may further include one or more secondary TRPs. Rearranging the sequence of FD bases may include circular shifting, for each secondary TRP of the one or more secondary TRPs, the sequence of FD bases corresponding to the secondary TRP to place the FD basis corresponding to the highest priority NZC of the sequence of NZCs for the corresponding secondary TRP to the first place at the sequence of the FD bases. For example, referring to FIG. 10, the plurality of TRPs may further include one or more secondary TRPs (e.g., TRP #2 in FIG. 10). Rearranging the sequence of FD bases may include circular shifting, for each secondary TRP of the one or more secondary TRPs, the sequence of FD bases corresponding to the secondary TRP to place the FD basis corresponding to the highest priority NZC of the sequence of NZCs (e.g., the FD basis corresponding to “local” strongest NZC in diagram 1030) to the first place at the sequence of the FD bases (i.e., the FD basis corresponding to the “local” strongest NZC in diagram 1030 is placed to the first place at the sequence in diagram 1040). Each of the one or more secondary TRPs may have its highest priority NZC, and each highest priority NZC may correspond to one secondary TRP of the one or more secondary TRPs.

In some aspects, permuting, for each TRP of the plurality of TRPs, the rearranged sequence of FD bases, may include permuting, for each TRP of the plurality of TRPs, the rearranged sequence of FD bases corresponding to the TRP based on a position of each FD basis in the rearranged sequence of FD bases with respect to the first place of the sequence. For example, referring to FIGS. 8A, 8B, and sequence (8), the rearranged sequence of FD bases may be permuted from an original index sequence of {0, 1, 2, . . . , 12}, as shown in FIG. 8A, to a permuted index sequence of {1, 12, 1, 11, . . . , 6}, as shown in FIG. 8B, according to the sequence (8).

In some aspects, the plurality of TRPs may further include one or more secondary TRPs. Rearranging the sequence of FD bases may include circular shifting, for each secondary TRP of the one or more secondary TRPs, the sequence of FD bases corresponding to the secondary TRP by the relative FD basis index offset corresponding to the primary TRP. For example, referring to FIG. 10, the plurality of TRPs may further include one or more secondary TRPs (e.g., TRP #2 in FIG. 10). Rearranging the sequence of FD bases may include circular shifting, for each secondary TRP of the one or more secondary TRPs, the sequence of FD bases corresponding to the secondary TRP by the relative FD basis index offset corresponding to the primary TRP (the sequence of FD bases in diagram 1050 is rearranged, by circular shifting by the relative FD basis index offset of 2, to the sequence of FD bases in diagram 1060).

In some aspects, permuting, for each TRP of the plurality of TRPs, the rearranged sequence of FD bases may include permuting, for the primary TRP of the plurality of TRPs, the rearranged sequence of FD bases corresponding to the primary TRP based on a position of each FD basis in the sequence of FD bases with respect to the first place of the sequence; and permuting, for each secondary TRP of the one or more secondary TRPs, the rearranged sequence of FD bases corresponding to the secondary TRP based on the relative FD basis index offset corresponding to the secondary TRP. For example, referring to the description in connection with FIG. 10 and Equation (10), for the primary TRP (e.g., the strongest TRP (TRP #1) in FIG. 10), the rearranged sequence of FD bases may be permuted based on a position of each FD basis in the sequence of FD bases with respect to the first place of the sequence (index 0 in diagram 1020). For each secondary TRP of the one or more secondary TRPs (e.g., TRP #2 in FIG. 10), the rearranged sequence of FD bases may be permuted on the relative FD basis index offset corresponding to the secondary TRP (e.g., the permutation is performed based on Equation (10), with the value of “offset” in Equation (10) being 2 in the example of diagrams 1050 and 1060 in FIG. 10).

In some aspects, FD bases for different TRPs may be independently selected, and each relative FD basis index offset may be less than or equal to a number of FD bases in the sequence of FD bases.

At 1608, the network entity may receive, from the UE, for each TRP of the plurality of TRPs, selected FD bases of the sequence of FD bases, where a same first number of the selected FD bases is selected from the sequence of FD bases for each TRP. For example, referring to FIG. 12, the network entity (base station 1204) may receive, at 1214, from the UE 1202, for each TRP of the plurality of TRPs, selected FD bases of the sequence of FD bases, and the same first number of the selected FD bases may be selected from the sequence of FD bases for each TRP. Further, step 1608 may be performed by the FD basis reception component 199.

At 1610, the network entity may select, in response to the number of FD bases in the sequences of FD bases being less than or equal to a threshold, the first number of FD bases from the sequence of FD bases for each TRP in the plurality of TRPs. For example, referring to FIG. 12, the network entity (base station 1204) may select, at 1222, one or more FD bases from the sequence of FD bases for each TRP of the plurality of TRPs. If the number of FD bases in the sequences of FD bases is less than or equal to a threshold, the network entity (base station 1204) may select the first number of FD bases from the sequence of FD bases for each TRP in the plurality of TRPs. Further, step 1610 may be performed by the FD basis reception component 199.

At 1612, the network entity may select, in response to the number of FD bases in the sequence of FD bases being greater than the threshold, a subset of FD bases from the sequence of FD bases for each TRP of the plurality of TRPs, and select the first number of FD bases from the subset of FD bases for each TRP in the plurality of TRPs. For example, referring to FIG. 12, the network entity (base station 1204) may select, at 1222, one or more FD bases from the sequence of FD bases for each TRP of the plurality of TRPs. If the number of FD bases in the sequences of FD bases is greater than the threshold, the network entity (base station 1204) may select a subset of FD bases from the sequence of FD bases for each TRP in the plurality of TRPs, and then select the first number of FD bases from the subset of FD bases for each TRP in the plurality of TRPs. Further, step 1612 may be performed by the FD basis reception component 199.

In some aspects, FD bases for at least two TRPs of the plurality of TRPs may be selected (e.g., commonly selected), and each relative FD basis index offset may have a second number of candidate values. The second number of candidate values may equal to a select number of selected FD bases. For example, for CJT with multiple TRPs, the FD bases for least two TRPs of the plurality of TRPs may be selected (e.g., commonly selected), and each relative FD basis index offset may have a second number of candidate values.

At 1614, the network entity may receive, from the UE, selected FD bases of the sequence of FD bases for the primary TRP, where a number of the selected FD bases is the select number. For example, referring to FIG. 12, the network entity (base station 1204) may receive, at 1214, from the UE 1202, selected FD bases of the sequence of FD bases for the primary TRP, where a number of the selected FD bases is the select number. Further, step 1614 may be performed by the FD basis reception component 199.

In some aspects, permuting the rearranged sequence of FD bases may include permuting the rearranged sequences of FD bases for two or more TRPs of the plurality of TRPs based on a priority of each FD basis of the sequences of FD bases. The FD bases in the first location of the sequence of FD bases may have a higher priority than the FD bases in a second location of the sequence of FD bases succeeding the first location for any of the one or more TRPs. For example, referring to diagrams 1110 and 1120 in FIG. 11, the rearranged sequences of FD bases for two or more TRPs of the plurality of TRPs may be permuted based on a priority of each FD basis of the sequences of FD bases, so that, after the permutation, the FD bases in the first location of the sequence of FD bases may have a higher priority than the FD bases in a second location of the sequence of FD bases succeeding the first location for any of the one or more TRPs (e.g., in diagrams 1110 and 1120, a FD basis in the first location of the sequence of FD bases in TRP #1 for TRP #2 has a higher priority than a FD basis in a second location of the sequence of FD bases succeeding the first location in TRP #1 or TRP #2).

In some aspects, permuting the rearranged sequence of FD bases may include permuting the rearranged sequences of FD bases for two or more TRPs of the plurality of TRPs based on a priority of each FD basis of the sequences of FD bases. The FD bases for a first TRP of the two or more TRPs may all have a higher priority than the FD bases for a second TRP of the two or more TRPs succeeding the first TRP. For example, referring to diagrams 1130 and 1140 in FIG. 11, the rearranged sequences of FD bases for two or more TRPs of the plurality of TRPs may be permuted based on a priority of each FD basis of the sequences of FD bases, so that, after the permutation, the FD bases for a first TRP of the two or more TRPs may all have a higher priority than the FD bases for a second TRP of the two or more TRPs succeeding the first TRP (e.g., in diagrams 1130 and 1140, a FD basis in TRP #1 has a higher priority than a FD basis in TRP #2).

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor 1724 communicates through the transceiver(s) 1722 via one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see 350 of FIG. 3) and include the additional modules of the apparatus 1704.

As discussed supra, the component 198 is configured to rearrange, for each TRP of a plurality of TRPs, a sequence of FD bases based on a relative FD basis index offset of a plurality of relative FD basis index offsets and a sequence of NZCs. Each NZC in the sequence of NZCs represents a priority of a corresponding FD basis of the sequence of FD bases. The component 198 is further configured to permute, for each TRP of the plurality of TRPs, the rearranged sequence of FD bases based on the sequence of NZCs and a corresponding relative FD basis index offset to obtain a set of permuted FD bases; and transmit, to a network entity, the plurality of relative FD basis index offsets for each layer of one or more layers and the set of permuted FD bases. The component 198 may be further configured to perform any of the aspects described in connection with the flowcharts in FIG. 13 and FIG. 14, and/or performed by the UE 1202 in FIG. 12. The component 198 may be within the cellular baseband processor 1724, the application processor 1706, or both the cellular baseband processor 1724 and the application processor 1706. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, includes means for rearranging, for each TRP of a plurality of TRPs, a sequence of FD bases based on a relative FD basis index offset of a plurality of relative FD basis index offsets and a sequence of NZCs. Each NZC in the sequence of NZCs may represent a priority of a corresponding FD basis of the sequence of FD bases. The apparatus 1704 may further include means for permuting, for each TRP of the plurality of TRPs, the rearranged sequence of FD bases based on the sequence of NZCs and a corresponding relative FD basis index offset to obtain a set of permuted FD bases, and means for transmitting, to a network entity, the plurality of relative FD basis index offsets for each layer of one or more layers and the set of permuted FD bases. The apparatus 1704 may further include means for performing any of the aspects described in connection with the flowcharts in FIG. 13 and FIG. 14, and/or aspects performed by the UE 1202 in FIG. 12. The means may be the component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

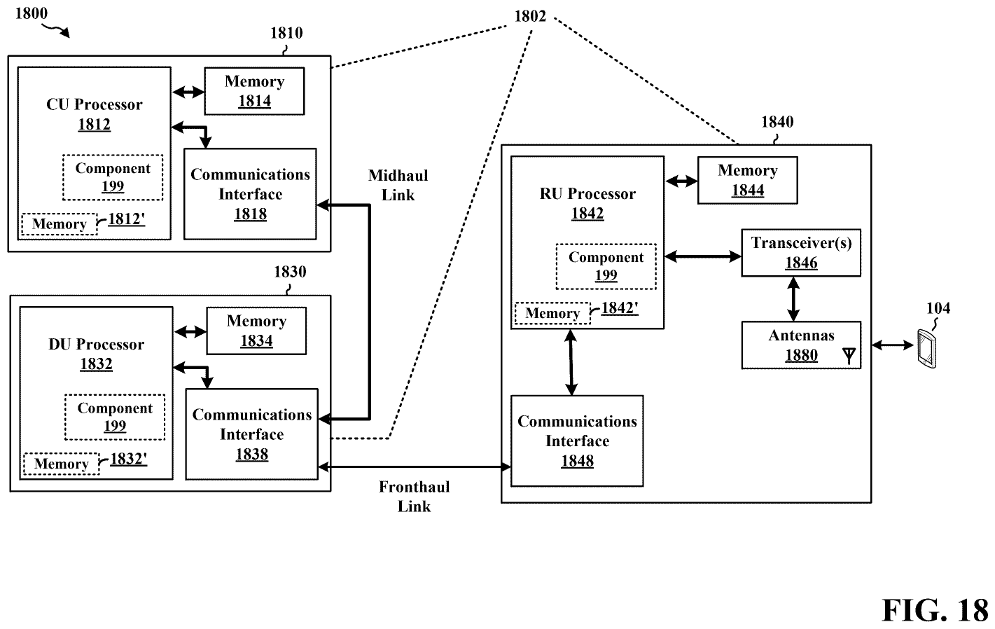

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to receive, from a UE, a plurality of relative FD basis index offsets for each layer of one or more layers, where the plurality of FD basis index offsets is associated with a set of permuted FD bases; rearrange, for each TRP of a plurality of TRPs, a sequence of FD bases based on a corresponding relative FD basis index offset of the plurality of relative FD basis index offsets and a sequence of NZCs. Each NZC in the sequence of NZCs may represent a priority of a corresponding FD basis of the sequence of FD bases. The component 199 may be further configured to permute, for each TRP of the plurality of TRPs, the rearranged sequence of FD bases based on the sequence of NZCs and a corresponding relative FD basis index offset to obtain the set of permuted FD bases. The component 199 may be further configured to perform any of the aspects described in connection with the flowcharts in FIG. 15 and FIG. 16, and/or performed by the base station 1204 in FIG. 12. The component 199 may be within one or more processors of one or more of the CU 1810, DU 1830, and the RU 1840. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 includes means for receiving, from a UE, a plurality of relative FD basis index offsets for each layer of one or more layers, where the plurality of FD basis index offsets is associated with a set of permuted FD bases, and means for rearranging, for each TRP of a plurality of TRPs, a sequence of FD bases based on a corresponding relative FD basis index offset of the plurality of relative FD basis index offsets and a sequence of NZCs. Each NZC in the sequence of NZCs may represent a priority of a corresponding FD basis of the sequence of FD bases. The network entity 1802 may further include means for permuting, for each TRP of the plurality of TRPs, the rearranged sequence of FD bases based on the sequence of NZCs and a corresponding relative FD basis index offset to obtain the set of permuted FD bases. The network entity 1802 may further include means for performing any of the aspects described in connection with the flowcharts in FIG. 15 and FIG. 16, and/or aspects performed by the base station 1204 in FIG. 12. The means may be the component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include rearranging, for each TRP of a plurality of TRPs, a sequence of FD bases based on a relative FD basis index offset of a plurality of relative FD basis index offsets and a sequence of NZCs, where each NZC in the sequence of NZCs represents a priority of a corresponding FD basis of the sequence of FD bases; permuting, for each TRP of the plurality of TRPs, the rearranged sequence of FD bases based on the sequence of NZCs and a corresponding relative FD basis index offset to obtain a set of permuted FD bases; and transmitting, to a network entity, the plurality of relative FD basis index offsets for each layer of one or more layers and the set of permuted FD bases. The methods provide FD basis index remapping and FD permutation for NZC ordering for multiple TRPs and improve the efficiency of wireless communication with multiple TRPs.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE. The method includes rearranging, for TRP of a plurality of TRPs, a sequence of FD bases based on a relative FD basis index offset of a plurality of relative FD basis index offsets and a sequence of NZCs, where each NZC in the sequence of NZCs represents a priority of a corresponding FD basis of the sequence of FD bases; permuting, for each TRP of the plurality of TRPs, the rearranged sequence of FD bases based on the sequence of NZCs and a corresponding relative FD basis index offset to obtain a set of permuted FD bases; and transmitting, to a network entity, the plurality of relative FD basis index offsets for each layer of one or more layers and the set of permuted FD bases.
Aspect 2 is the method of aspect 1, where rearranging the sequence of FD bases includes circular shifting the sequence of FD bases corresponding to a primary TRP of the plurality of TRPs according to the relative FD basis index offset corresponding to the primary TRP to place an FD basis corresponding to the highest priority NZC of the sequence of NZCs to a first place at the sequence of the FD bases.
Aspect 3 is the method of aspect 2, where the plurality of TRPs further includes one or more secondary TRPs, and rearranging the sequence of FD bases includes: circular shifting, for each secondary TRP of the one or more secondary TRPs, the sequence of FD bases corresponding to the secondary TRP to place the FD basis corresponding to the highest priority NZC of the sequence of NZCs to the first place at the sequence of the FD bases.
Aspect 4 is the method of aspect 3, where permuting, for each TRP of the plurality of TRPs, the rearranged sequence of FD bases includes permuting, for each TRP of the plurality of TRPs, the rearranged sequence of FD bases corresponding to the TRP based on a position of each FD basis in the rearranged sequence of FD bases with respect to the first place of the sequence.
Aspect 5 is the method of any of aspects 2-4, where the plurality of TRPs further includes one or more secondary TRPs, and rearranging the sequence of FD bases includes: circular shifting, for each secondary TRP of the one or more secondary TRPs, the sequence of FD bases corresponding to the secondary TRP by the relative FD basis index offset corresponding to the primary TRP.
Aspect 6 is the method of aspect 5, where permuting, for each TRP of the plurality of TRPs, the rearranged sequence of FD bases includes permuting, for the primary TRP of the plurality of TRPs, the rearranged sequence of FD bases corresponding to the primary TRP based on a position of each FD basis in the sequence of FD bases with respect to the first place of the sequence; and permuting, for each secondary TRP of the one or more secondary TRPs, the rearranged sequence of FD bases corresponding to the secondary TRP based on the relative FD basis index offset corresponding to the secondary TRP.
Aspect 7 is the method of any of aspects 2-6, where FD bases for different TRPs are independently selected, and each relative FD basis index offset is less than or equal to a number of FD bases in the sequence of FD bases.
Aspect 8 is the method of aspect 7, where the method further includes selecting, for each TRP of the plurality of TRPs, a same first number of selected FD bases from the sequence of FD bases; and transmitting, to the network entity, for each TRP of the plurality of TRPs, the selected FD bases of the sequence of FD bases.
Aspect 9 is the method of aspect 8, where selecting the first number of selected FD bases from the sequence of FD bases includes: selecting, in response to the number of FD bases in the sequences of FD bases being less than or equal to a threshold, the first number of FD bases from the sequence of FD bases for each TRP in the plurality of TRPs; and selecting, in response to the number of FD bases in the sequence of FD bases being greater than the threshold, a subset of FD bases from the sequence of FD bases for each TRP of the plurality of TRPs, and selecting the first number of FD bases from the subset of FD bases for each TRP in the plurality of TRPs.
Aspect 10 is the method of any of aspects 2-9, where FD bases for at least two TRPs of the plurality of TRPs are selected (e.g., commonly selected), and each relative FD basis index offset has a second number of candidate values, where the second number of candidate values is equal to a select number of selected FD bases.
Aspect 11 is the method of aspect 10, where the method further includes: selecting, for each TRP of the plurality of TRPs, the select number of selected FD bases from the sequence of FD bases; and transmitting, to the network entity, the selected FD bases of the sequence of FD bases for the primary TRP.
Aspect 12 is the method of any of aspects 2-11, where permuting the rearranged sequence of FD bases includes: permuting the rearranged sequences of FD bases for two or more TRPs of the plurality of TRPs based on a priority of each FD basis of the sequences of FD bases. The FD bases in the first location of the sequence of FD bases have a higher priority than the FD bases in a second location of the sequence of FD bases succeeding the first location for any of the one or more TRPs.
Aspect 13 is the method of any of aspects 2-12, where permuting the rearranged sequence of FD bases includes: permuting the rearranged sequences of FD bases for two or more TRPs of the plurality of TRPs based on a priority of each FD basis of the sequences of FD bases. The FD bases for a first TRP of the two or more TRPs all have a higher priority than the FD bases for a second TRP of the two or more TRPs succeeding the first TRP.
Aspect 14 is an apparatus for wireless communication at a UE, including: a memory; and at least one processor coupled to the memory and, based at least in part on information stored in the memory, the at least one processor is configured to perform the method of any of aspects 1-13.
Aspect 15 is the apparatus of aspect 14, further including at least one of a transceiver or an antenna coupled to the at least one processor and configured to transmit the plurality of relative FD basis index offsets.
Aspect 16 is an apparatus for wireless communication including means for implementing the method of any of aspects 1-13.
Aspect 17 is a computer-readable medium (e.g., a non-transitory computer-readable medium) storing computer-executable code, where the code when executed by a processor causes the processor to implement the method of any of aspects 1-13.
Aspect 18 is a method of wireless communication at a network entity. The method includes: receiving, from a UE, a plurality of relative FD basis index offsets for each layer of one or more layers, where the plurality of FD basis index offsets is associated with a set of permuted FD bases; rearranging, for each TRP of a plurality of TRPs, a sequence of FD bases based on a corresponding relative FD basis index offset of the plurality of relative FD basis index offsets and a sequence of NZCs, where each NZC in the sequence of NZCs represents a priority of a corresponding FD basis of the sequence of FD bases; and permuting, for each TRP of the plurality of TRPs, the rearranged sequence of FD bases based on the sequence of NZCs and a corresponding relative FD basis index offset to obtain the set of permuted FD bases.
Aspect 19 is the method of aspect 18, where rearranging the sequence of FD bases includes: circular shifting the sequence of FD bases corresponding to a primary TRP of the plurality of TRPs according to the relative FD basis index offset corresponding to the primary TRP to place an FD basis corresponding to the highest priority NZC of the sequence of NZCs to a first place at the sequence of the FD bases.
Aspect 20 is the method of aspect 19, where the plurality of TRPs further includes one or more secondary TRPs, and rearranging the sequence of FD bases includes: circular shifting, for each secondary TRP of the one or more secondary TRPs, the sequence of FD bases corresponding to the secondary TRP to place the FD basis corresponding to the highest priority NZC of the sequence of NZCs to the first place at the sequence of the FD bases.
Aspect 21 is the method of aspect 20, where permuting, for each TRP of the plurality of TRPs, the rearranged sequence of FD bases includes: permuting, for each TRP of the plurality of TRPs, the rearranged sequence of FD bases corresponding to the TRP based on a position of each FD basis in the rearranged sequence of FD bases with respect to the first place of the sequence.
Aspect 22 is the method of any of aspects 19-21, where the plurality of TRPs further includes one or more secondary TRPs, and rearranging the sequence of FD bases further includes: circular shifting, for each secondary TRP of the one or more secondary TRPs, the sequence of FD bases corresponding to the secondary TRP by the relative FD basis index offset corresponding to the primary TRP.
Aspect 23 is the method of aspect 22, where permuting, for each TRP of the plurality of TRPs, the rearranged FD bases includes: permuting, for the primary TRP of the plurality of TRPs, the rearranged sequence of FD bases corresponding to the primary TRP based on a position of each FD basis in the sequence of FD bases with respect to the first place of the sequence; and permuting, for each secondary TRP of the one or more secondary TRPs, the rearranged sequence of FD bases corresponding to the secondary TRP based on the relative FD basis index offset corresponding to the secondary TRP.
Aspect 24 is the method of any of aspects 19-23, where FD bases for different TRPs are independently selected, and each relative FD basis index offset is less than or equal to a number of FD bases in the sequence of FD bases.
Aspect 25 is the method of aspect 24, where the method further includes: receiving, from the UE, for each TRP of the plurality of TRPs, selected FD bases of the sequence of FD bases. The same first number of the selected FD bases is selected from the sequence of FD bases for each TRP.
Aspect 26 is the method of aspect 25, where selecting the first number of selected FD bases from the sequence of FD bases includes: selecting, in response to the number of FD bases in the sequences of FD bases being less than or equal to a threshold, the first number of FD bases from the sequence of FD bases for each TRP in the plurality of TRPs; and selecting, in response to the number of FD bases in the sequence of FD bases being greater than the threshold, a subset of FD bases from the sequence of FD bases for each TRP of the plurality of TRPs, and selecting the first number of FD bases from the subset of FD bases for each TRP in the plurality of TRPs.
Aspect 27 is the method of any of aspects 19-27, where FD bases for at least two TRPs of the plurality of TRPs are selected (e.g., commonly selected), and each relative FD basis index offset has a second number of candidate values, where the second number of candidate values is equal to a select number of selected FD bases.
Aspect 28 is the method of aspect 27, where the method further includes: receiving, from the UE, selected FD bases of the sequence of FD bases for the primary TRP. The number of the selected FD bases is the select number.
Aspect 29 is the method of any of aspects 19-28, where permuting the rearranged sequence of FD bases further includes: permuting the rearranged sequences of FD bases for two or more TRPs of the plurality of TRPs based on a priority of each FD basis of the sequences of FD bases. The FD bases in the first location of the sequence of FD bases have a higher priority than the FD bases in a second location of the sequence of FD bases succeeding the first location for any of the one or more TRPs.
Aspect 30 is the method of any of aspects 19-29, where permuting the rearranged sequence of FD bases further includes: permuting the rearranged sequences of FD bases for two or more TRPs of the plurality of TRPs based on a priority of each FD basis of the sequences of FD bases. The FD bases for a first TRP of the two or more TRPs all have a higher priority than the FD bases for a second TRP of the two or more TRPs succeeding the first TRP.
Aspect 31 is an apparatus for wireless communication at a network entity, including: a memory; and at least one processor coupled to the memory and, based at least in part on information stored in the memory, the at least one processor is configured to perform the method of any of aspects 18-30.
Aspect 32 is the apparatus of aspect 31, further including at least one of a transceiver or an antenna coupled to the at least one processor and configured to receive the plurality of relative FD basis index offsets.
Aspect 33 is an apparatus for wireless communication including means for implementing the method of any of aspects 18-30.
Aspect 34 is a computer-readable medium (e.g., a non-transitory computer-readable medium) storing computer-executable code, where the code when executed by a processor causes the processor to implement the method of any of aspects 18-30.

1. An apparatus for wireless communication at a user equipment (UE), comprising:
memory; and
at least one processor coupled to the memory and, based at least in part on information stored in the memory, the at least one processor is configured to:
rearrange, for each transmit reception point (TRP) of a plurality of TRPs, a sequence of frequency domain (FD) bases based on a relative FD basis index offset of a plurality of relative FD basis index offsets and a sequence of non-zero coefficients (NZCs), wherein each NZC in the sequence of NZCs represents a priority of a corresponding FD basis of the sequence of FD bases:
permute, for each TRP of the plurality of TRPs, the rearranged sequence of FD bases based on the sequence of NZCs and a corresponding relative FD basis index offset to obtain a set of permuted FD bases; and
transmit, to a network entity, the plurality of relative FD basis index offsets for each layer of one or more layers and the set of permuted FD bases.

2. (canceled)

3. The apparatus of claim 1, wherein, to rearrange the sequence of FD bases, the at least one processor is configured to:
circular shift the sequence of FD bases corresponding to a primary TRP of the plurality of TRPs according to the relative FD basis index offset corresponding to the primary TRP to place an FD basis corresponding to a highest priority NZC of the sequence of NZCs to a first place at the sequence of FD bases.

4. The apparatus of claim 3, wherein the plurality of TRPs further includes one or more secondary TRPs, and wherein, to rearrange the sequence of FD bases, the at least one processor is further configured to:
circular shift, for each secondary TRP of the one or more secondary TRPs, the sequence of FD bases corresponding to the secondary TRP to place the FD basis corresponding to the highest priority NZC of the sequence of NZCs for the corresponding secondary TRP to the first place at the sequence of FD bases.

5. The apparatus of claim 4, wherein, to permute, for each TRP of the plurality of TRPs, the rearranged sequence of FD bases, the at least one processor is configured to:
permute, for each TRP of the plurality of TRPs, the rearranged sequence of FD bases corresponding to the TRP based on a position of each FD basis in the rearranged sequence of FD bases with respect to the first place of the sequence of FD bases.

6. The apparatus of claim 3, wherein the plurality of TRPs further includes one or more secondary TRPs, and wherein, to rearrange the sequence of FD bases, the at least one processor is further configured to:
circular shift, for each secondary TRP of the one or more secondary TRPs, the sequence of FD bases corresponding to the secondary TRP by the relative FD basis index offset corresponding to the primary TRP.

7. The apparatus of claim 6, wherein, to permute, for each TRP of the plurality of TRPs, the rearranged sequence of FD bases, the at least one processor is configured to:
permute, for the primary TRP of the plurality of TRPs, the rearranged sequence of FD bases corresponding to the primary TRP based on a position of each FD basis in the sequence of FD bases with respect to the first place of the sequence of FD bases; and
permute, for each secondary TRP of the one or more secondary TRPs, the rearranged sequence of FD bases corresponding to the secondary TRP based on the relative FD basis index offset corresponding to the secondary TRP.

8. The apparatus of claim 3, wherein FD bases for different TRPs are configured to be independently selected, and wherein each relative FD basis index offset is less than or equal to a number of FD bases in the sequence of FD bases.

9. The apparatus of claim 8, wherein the at least one processor is further configured to:
select, for each TRP of the plurality of TRPs, a same first number of selected FD bases from the sequence of FD bases; and
transmit, to the network entity, for each TRP of the plurality of TRPs, the selected FD bases of the sequence of FD bases.

10. The apparatus of claim 9, wherein, to select the first number of selected FD bases from the sequence of FD bases, the at least one processor is configured to:
select, in response to the number of FD bases in the sequence of FD bases being less than or equal to a threshold, the first number of FD bases from the sequence of FD bases for each TRP in the plurality of TRPs; and
select, in response to the number of FD bases in the sequence of FD bases being greater than the threshold, a subset of FD bases from the sequence of FD bases for each TRP of the plurality of TRPs, and select the first number of FD bases from the subset of FD bases for each TRP in the plurality of TRPs.

11. The apparatus of claim 3, wherein FD bases for at least two TRPs of the plurality of TRPs are selected, and wherein each relative FD basis index offset has a second number of candidate values, wherein the second number of candidate values is equal to a select number of selected FD bases.

12. The apparatus of claim 11, wherein the at least one processor is further configured to:
select, for each TRP of the plurality of TRPs, the select number of selected FD bases from the sequence of FD bases; and
transmit, to the network entity, the selected FD bases of the sequence of FD bases for the primary TRP.

13. The apparatus of claim 3, wherein, to permute the rearranged sequence of FD bases, the at least one processor is configured to:
permute the rearranged sequence of FD bases for two or more TRPs of the plurality of TRPs based on a priority of each FD basis of the sequence of FD bases, wherein the FD bases in a first location of the sequence of FD bases have a higher priority than the FD bases in a second location of the sequence of FD bases succeeding the first location for any of the one or more TRPs.

14. The apparatus of claim 3, wherein, to permute the rearranged sequence of FD bases, the at least one processor is configured to:
permute the rearranged sequence of FD bases for two or more TRPs of the plurality of TRPs based on a priority of each FD basis of the sequence of FD bases, wherein the FD bases for a first TRP of the two or more TRPs all have a higher priority than the FD bases for a second TRP of the two or more TRPs succeeding the first TRP.

15. An apparatus for wireless communication at a network entity, comprising:
memory; and
at least one processor coupled to the memory and, based at least in part on information stored in the memory, the at least one processor is configured to:
receive, from a user equipment (UE), a plurality of relative frequency domain (FD) basis index offsets for each layer of one or more layers, wherein the plurality of FD basis index offsets is associated with a set of permuted FD bases:
rearrange, for each transmit reception point (TRP) of a plurality of TRPs, a sequence of FD bases based on a corresponding relative FD basis index offset of the plurality of relative FD basis index offsets and a sequence of non-zero coefficients (NZCs), wherein each NZC in the sequence of NZCs represents a priority of a corresponding FD basis of the sequence of FD bases; and
permute, for each TRP of the plurality of TRPs, the rearranged sequence of FD bases based on the sequence of NZCs and the corresponding relative FD basis index offset to obtain the set of permuted FD bases.

16. (canceled)

17. The apparatus of claim 15, wherein, to rearrange the sequence of FD bases, the at least one processor is configured to:
circular shift the sequence of FD bases corresponding to a primary TRP of the plurality of TRPs according to the relative FD basis index offset corresponding to the primary TRP to place an FD basis corresponding to a highest priority NZC of the sequence of NZCs to a first place at the sequence of FD bases.

18. The apparatus of claim 17, wherein the plurality of TRPs further includes one or more secondary TRPs, and wherein, to rearrange the sequence of FD bases, the at least one processor is further configured to:
circular shift, for each secondary TRP of the one or more secondary TRPs, the sequence of FD bases corresponding to the secondary TRP to place the FD basis corresponding to the highest priority NZC of the sequence of NZCs for the corresponding secondary TRP to the first place at the sequence of FD bases.

19. The apparatus of claim 18, wherein, to permute, for each TRP of the plurality of TRPs, the rearranged sequence of FD bases, the at least one processor is configured to:
permute, for each TRP of the plurality of TRPs, the rearranged sequence of FD bases corresponding to the TRP based on a position of each FD basis in the rearranged sequence of FD bases with respect to the first place of the sequence of FD bases.

20. The apparatus of claim 17, wherein the plurality of TRPs further includes one or more secondary TRPs, and wherein, to rearrange the sequence of FD bases, the at least one processor is further configured to:
circular shift, for each secondary TRP of the one or more secondary TRPs, the sequence of FD bases corresponding to the secondary TRP by the relative FD basis index offset corresponding to the primary TRP.

21. The apparatus of claim 20, wherein, to permute, for each TRP of the plurality of TRPs, the rearranged FD bases, the at least one processor is configured to:
permute, for the primary TRP of the plurality of TRPs, the rearranged sequence of FD bases corresponding to the primary TRP based on a position of each FD basis in the sequence of FD bases with respect to the first place of the sequence of FD bases; and
permute, for each secondary TRP of the one or more secondary TRPs, the rearranged sequence of FD bases corresponding to the secondary TRP based on the relative FD basis index offset corresponding to the secondary TRP.

22. (canceled)

23. (canceled)

24. (canceled)

25. (canceled)

26. (canceled)

27. (canceled)

28. (canceled)

29. A method for wireless communication at a user equipment (UE), comprising:
rearranging, for each transmit reception point (TRP) of a plurality of TRPs, a sequence of frequency domain (FD) bases based on a relative FD basis index offset of a plurality of relative FD basis index offsets and a sequence of non-zero coefficients (NZCs), wherein each NZC in the sequence of NZCs represents a priority of a corresponding FD basis of the sequence of FD bases:
permuting, for each TRP of the plurality of TRPs, the rearranged sequence of FD bases based on the sequences of NZCs and a corresponding relative FD basis index offset to obtain a set of permuted FD bases; and
transmitting, to a network entity, the plurality of relative FD basis index offsets for each layer of one or more layers and the set of permuted FD bases.

30. (canceled)
